(19) United States
(12) Patent Application Publication
(10) Pub. No.: US 2025/0065268 A1
(43) Pub. Date: Feb. 27, 2025

(54) Method And Apparatus For Removing A Target Substance From A Gas

(71) Applicant: Verdus Technologies Pte. Ltd., Singapore (SG)

(72) Inventor: Avichal Agrawal, Singapore (SG)

(21) Appl. No.: 18/728,290

(22) PCT Filed: Jan. 11, 2023
(86) PCT No.: PCT/SG2023/050021

§ 371 Date: Jul. 11, 2024

(30) Foreign Application Priority Data
Jan. 11, 2022 (SG) 10202200269R

(51) Int. Cl. B01D 53/96; B01D 15/36; B01D 53/50; B01D 53/62; B01D 53/78; B01D 61/46; B01D 69/02

(52) U.S. Cl. CPC B01D 53/96; B01D 15/361; B01D 53/507; B01D 53/62; B01D 53/78; B01D 53/965; B01D 61/46; B01D 69/02; B01D 2257/302; B01D 2257/504; B01D 2325/42

(57) ABSTRACT

A method for removing a target substance from a gas is provided. The method comprises providing a capture medium comprising an alkaline aqueous solution for dissolving the target substance comprised in the gas to form a target ion in the capture medium, contacting the target substance comprised in the gas with the capture medium to form a target ion in the capture medium, and transporting the target ion comprised in the capture medium to a process medium via an ion transport mechanism, wherein the process medium comprises an aqueous solution comprising an ion having an electric charge opposite to that of the target ion, and which interacts with the target ion to form a compound in the process medium, wherein the ion transport mechanism is adapted to allow a flow of ions between the capture medium and the process medium to maintain charge balance. An apparatus for removing a target substance from a gas, and use of the method and apparatus disclosed herein in treatment of industrial exhaust gas or air are also provided.

### CROSS-REFERENCE TO RELATED APPLICATION

This application is a national phase entry under 35 U.S.C. § 371 of International Patent Application PCT/SG2023/050021, filed Jan. 11, 2023, designating the United States of America and published in English as International Patent Publication WO2023/136778 on Jul. 20, 2023, which claims the benefit of priority of Singapore patent application number 10202200269R, filed 11 Jan. 2022, the contents of which being hereby incorporated by reference in its entirety for all purposes.

### TECHNICAL FIELD

The invention relates to a method and an apparatus for removing a target substance from a gas.

### BACKGROUND

The main components of pollution caused by human activity are acidic gases such as carbon dioxide (CO₂), carbon monoxide (CO), sulphur dioxide (SO₂), nitrogen oxides (NOx), chlorine (Cl₂), and hydrogen chloride (HCl). These acidic gases mix with air and water to form acidic solutions (aqueous solutions containing acidic ions), which create havoc for humans and other natural life. Hence, it is important to be able to remove such gases from the air or water for a healthier planet. Also, these gases mix with water and cause precipitation and/or acidification, leading to higher maintenance costs in industrial processes.

In the direct capture mechanisms, the aim is to dissolve such target gases from the atmospheric air or industrial exhaust pipes into a capture medium in an economical manner to remove or reduce the concentration of such target gases from atmospheric air or exhaust pipes. These target gases dissolve in water to form respective target ions in alkaline media but have low solubility in acidic aqueous solutions.

Sodium hydroxide solution can dissolve such target gases to form respective sodium salt solutions with the target ions formed by dissolving such target gases in water. For example, sodium hydroxide can react with CO₂ and SO₂ to form sodium carbonate or bicarbonate and sodium sulphate. Sodium hydroxide is generated by the chloralkali process, i.e., by electrolysis of sodium chloride solution. This is an expensive process and consumes much electricity. Sodium salts can be thermally decomposed to liberate the target gas stream. However, this is also very energy-intensive and requires a high temperature. For example, sodium carbonate can be heated to liberate CO₂ gas at temperatures well over 1,000 degree Celsius. Hence, although technically feasible, this process is very expensive and energy intensive.

Calcium hydroxide solution can dissolve such target gases to form respective calcium salt solutions with the target ions formed by dissolving such target gases in water. For example, calcium hydroxide can react with CO₂ and SO₂ to form calcium carbonate or bicarbonate and calcium sulphate. Calcium hydroxide can be generated by dissolving calcium oxide in water. This is an exothermic process and wastes much energy. Calcium salts can be thermally decomposed to produce the target gas stream. For example, calcium carbonate can be heated to liberate CO₂ gas at nearly 900 degrees Celsius. Thus, although technically feasible, this is very energy-intensive and needs a very high temperature (although not as high a temperature as needed for the sodium process described above, and less expensive). Also, calcium carbonate and calcium sulphate precipitate and form scales in the capture equipment. Therefore, much more maintenance is required for calcium based capture process, as compared to sodium process described above.

Zinc chloride dissolves in water to form acidic aqueous solutions. Hence, it cannot be directly used to capture target gases such as CO₂. Zinc hydroxide is non-soluble in water, so this cannot be used for such target gases to form zinc salts since the reaction is very slow to form zinc carbonate. Another problem with zinc based process is managing the precipitation and scaling, the same as the problem with calcium based process described above. Thus, this also would need to be managed for a technically and economically feasible process to be developed.

Strontium chloride is highly soluble in water. It can capture target gases like CO₂ and SO₂ to form strontium carbonate or strontium sulphate, which are not soluble in water and precipitate out from water. However, scaling and precipitation create many maintenance issues.

Alkaline capture medium based on ions of barium, mercury, lead, iron, and copper usually form poisonous salts. Therefore, they are not recommended. When used, extra precautions are needed, thus impacting economic viability of the process. Moreover, precipitation and scaling challenges with these salts can also impact their economic viability.

In light of the above, there is a need for improved methods and apparatus for removal of target substances from gas.

### SUMMARY

Various embodiments refer in a first aspect to a method for removing a target substance from a gas, the method comprising providing a capture medium comprising an alkaline aqueous solution for dissolving the target substance comprised in the gas to form a target ion in the capture medium, contacting the target substance comprised in the gas with the capture medium to form a target ion in the capture medium, and transporting the target ion comprised in the capture medium to a process medium via an ion transport mechanism, wherein the process medium comprises an aqueous solution comprising an ion having an electric charge opposite to that of the target ion, and which interacts with the target ion to form a compound in the process medium, wherein the ion transport mechanism is adapted to allow a flow of ions between the capture medium and the process medium to maintain charge balance.

Various embodiments refer in a second aspect to an apparatus for removing a target substance from a gas, the apparatus comprising
a capture medium comprising an alkaline aqueous solution for dissolving the target substance comprised in the gas to form a target ion in the capture medium,
a process medium comprising an aqueous solution having an ion with an electric charge opposite to that of the target ion, and which is adapted to interact with the target ion to form a compound in the process medium, and
an ion transport mechanism adapted to allow transport of the target ion from the capture medium to the process medium, and a flow of ions between the capture medium and the process medium to maintain charge balance.

Various embodiments refer to a third aspect to use of the method according to the first aspect or the apparatus according to the second aspect in treatment of industrial exhaust gas or air.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 is a schematic diagram of an apparatus according to an embodiment. In the embodiment shown, a gas containing a target substance such as CO₂ and SO₂ is introduced into a capture medium, which is housed in a capture chamber. The target substance dissolves in the capture medium to form target ions in the capture medium. The target ions are being transported to a process medium housed in a process chamber via an ion transport mechanism, such as a selectively permeable ion exchange membrane system or an ion exchange resin system. The ion transport mechanism keeps the capture medium and the process medium separated, and prevents them from mixing. The target ions interacts with an ion having an electric charge opposite to that of the target ion in the process medium to form a compound, which precipitates from the process medium. The compound may have lower solubility in the process medium.

FIG. 2 is a graph showing log concentration (log C) vs pH for H₂Ox, HOx⁻, H⁺, Ox²⁻ and OH⁻ according to embodiments. As can be seen from the graph, at pH=9.5 and above, hydroxyl ions (OH⁻) dominate over H⁺ ions and HOx⁻ ions. This means that the capture medium is able to dissolve an acid anhydride at pH 9.5 or more. Both strong and weak acid anhydrides can be dissolved. Further, OH⁻ dominate Ox²⁻ ions at pH greater than 12, which may mean that weak acid anhydrides can only be captured when the capture medium is at pH of greater than 12 in the presence of oxidizing gases such as oxygen (O₂). In this regard, based on partial pressure of CO₂ and O₂ in air from the experiments carried out, the capture medium demonstrates an economical level of capture kinetics of weak acid anhydrides at pH 13.5 and above in the presence of oxidizing gases such as O₂. From the graph, it can also be seen that concentration of H⁺ increases as pH decreases. Accordingly, the process medium, having a lower pH than the capture medium, has a higher H⁺ concentration than the capture medium. In embodiments whereby H⁺ ions are being moved from the capture medium to the process medium hence against the concentration gradient, which may be carried out for charge balancing purposes, electrical energy may be used for movement of the ions. Target ions, on the other hand, may move along the concentration gradient, thus electrical energy to move the target ions may not be required.

FIG. 3 is a graph showing log concentration (log [concentration (mol kg⁻¹)]) vs pH for CO₂, H⁺, HCO₃⁻, OH⁻ and CO₃²⁻ according to embodiments. As can be seen from the graph, at pH=9.5 and above, CO₃²⁻ (carbonate ion) is the dominant form of aqueous carbonic ions. When carbonate ions are moved from capture medium to process medium, proportion of carbonate ions to other ions such as bicarbonate ions or hydroxyl ions decreases. To maintain the balance, bicarbonate ions may convert to carbonate ions in the capture medium. As such, even when the carbonate ions are moved from the capture medium to the process medium, concentration of carbonate ions in the capture medium can be maintained, i.e. does not decrease. From the graph, it can also be seen than OH⁻ ions are more concentrated than CO₃²⁻ ions at higher pH levels. Therefore, if the CO₃²⁻ ions are moved across the ion transport mechanism (such as ion exchange membrane) when the capture medium is at a higher pH, likelihood of OH⁻ ions being carried over to the process medium may correspondingly be higher. As this may be undesirable, in embodiments whereby a high pH such as 13.5 or more is being used in the capture medium, the pH may be brought down to lower levels in the range of 9.5 to 13.5, before transporting the target ions from the capture medium to the process medium. In so doing, better efficiency may be achieved.

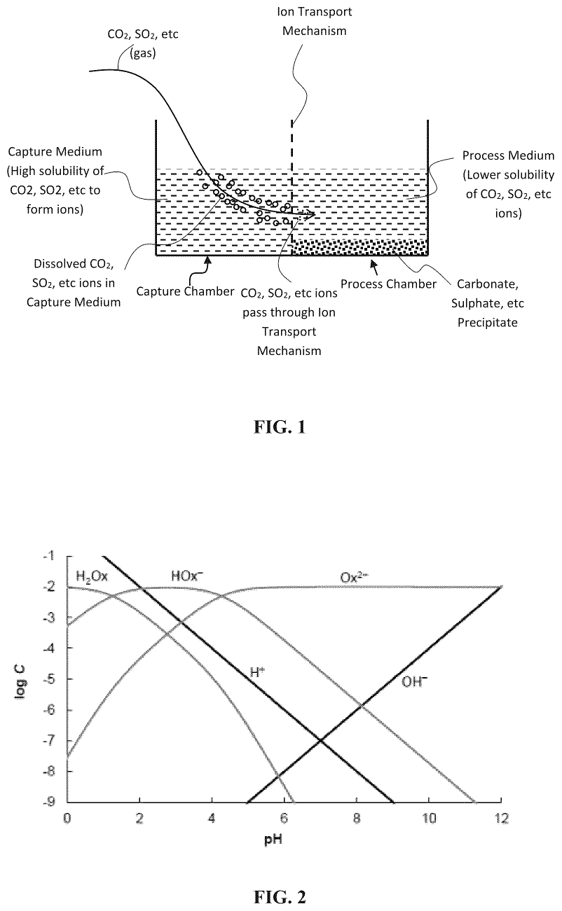

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

As disclosed herein, a method for removing a target substance from a gas is provided. Advantageously, methods disclosed herein are able to remove some or all of the target substances from gas economically, while also managing scaling and precipitation issues economically with reduced maintenance requirements. Compounds formed in the process medium may be extracted from the process medium in the form of precipitate or gas. As the compounds may constitute valuable and industrially important raw materials, costs of running the disclosed method may be recovered. Furthermore, materials used in methods disclosed herein may be regenerated in an economical manner.

By the term “removing” or “removed”, this means at least reducing an amount of the target substance in the gas following application of methods disclosed herein. In some embodiments, the target substance is completely removed from the gas.

The term “target substance” refers to a component or a compound comprised in a gas that can be identified and removed due to its physical and/or chemical properties which allow for its interaction with the capture medium. For example, the target substance may be one that is able to dissolve in the capture medium.

In various embodiments, the target substance comprises an acid anhydride, otherwise termed herein as “acidic gases”, such as carbon dioxide (CO₂) and/or sulphur dioxide (SO₂).

The method disclosed herein may comprise providing a capture medium comprising an alkaline aqueous solution for dissolving the target substance comprised in the gas to form a target ion in the capture medium.

The alkaline aqueous solution may comprise one or more of a sodium ion (Na⁺), a potassium ion (K⁺), a calcium ion (Ca²⁺), and a magnesium ion (Mg²⁺). In various embodiments, the alkaline aqueous solution comprises a sodium ion and/or a potassium ion. In some embodiments, the alkaline aqueous solution comprises a sodium ion. The above-mentioned ions may form positively charged ions or cations in the capture medium. For charge balancing purposes, the capture medium may further comprise negatively charged ions or anions. In various embodiments, the capture medium comprises a chloride (Cl⁻) ion.

The capture medium may be an alkaline aqueous solution having a pH of 9.5 or greater, such as a pH of at least 10, at least 11, at least 12, at least 13, at least 13.5, or be in the range of 9.5 to 10.5, 9.5 to 11.5, 9.5 to 12.5, 9.5 to 13.5, 10.5 to 13.5, 11.5 to 13.5, or 12.5 to 13.5. In various embodiments, capture medium has a pH of at least 9.5.

pH of the capture medium may depend on factors such as type of target substance and the gas used. As mentioned above, the target substance may be an acid anhydride such as CO₂ and/or SO₂. When the target substance is CO₂ and the gas is pure CO₂, for example, pH of the capture medium may be 9.5 or greater. By the term “pure CO₂”, this means that CO₂ content in the gas is 90 wt % or more, such as 92 wt % or more, 95 wt % or more, 98 wt % or more, or 100% CO₂. As another example, when the target substance is SO₂, pH of the capture medium may be 9.5 or greater, regardless of the type of gas the SO₂ is present in.

In some embodiments, when the target substance is CO₂ and the gas is not in the form of pure CO₂, the capture medium may be an alkaline aqueous solution having a pH of 13.5 or greater. For example, when the gas does not contain 90 wt % or more CO₂, such as in the case of air, the capture medium may be an alkaline aqueous solution having a pH of 13.5 or greater.

In various embodiments, the target substance comprised in the gas is dissolved to form a target ion in the capture medium. When the target substance is CO₂, for example, the target ion may be CO₃²⁻. When the target substance is SO₂, for example, the target ion may be SO₄²⁻.

The capture medium may or may not comprise the target ion prior to contacting the target substance comprised in the gas with the capture medium. In embodiments wherein the capture medium contains the target ion prior to contacting the target substance in the gas with the capture medium, pH of the capture medium may be less than 9.5 due to presence of the target ion. As such, it may be contacted with an alkali to raise the pH such that pH is 9.5 or more before use. In various embodiments, the capture medium comprises the target ion, and providing the capture medium comprises treating the capture medium with an alkali so that a pH of the capture medium is 9.5 or greater.

The method may comprise contacting the target substance comprised in the gas with the capture medium to form a target ion in the capture medium. The contacting may generally be carried out at ambient conditions, such as atmospheric pressure and a temperature in the range of about 20° C. to about 40° C., such as about 25° C. to about 35° C., about 28° C. to about 36° C., or about 30° C.

In embodiments wherein the capture medium is an alkaline aqueous solution having a pH of 13.5 or greater for use when the target substance is CO₂ and the gas is not in the form of pure CO₂, contacting the target substance comprised in the gas with the capture medium to form the target ion in the capture medium may further comprise reducing pH of the capture medium to a pH in the range of 9.5 to 13.5. Reducing pH of the capture medium may be carried out by treating the capture medium with an acid, such as hydrochloric acid (HCl), which is able to substantially dissociate into its component ions, or with salts, such as zinc chloride or strontium chloride, which are able to hydrolyse and form corresponding acids, such as HCl. This may be carried out prior to transporting of the target ion comprised in the capture medium to the process medium. As mentioned above, better efficiency may be achieved by reducing pH of the capture medium to a pH in the range of 9.5 to 13.5 prior to transporting of the target ion comprised in the capture medium to the process medium, as likelihood of other ions, such as OH⁻, being moved from the capture medium to the process medium due to the higher pH may be reduced.

With forming of the target ion, methods disclosed herein may comprise transporting the target ion comprised in the capture medium to a process medium via an ion transport mechanism.

The term “process medium” refers to a reagent that is used in tandem with the capture medium to allow removal and/or regeneration of the target substance. Advantageously, the use of capture medium and process medium according to methods disclosed herein may synergistically enhance removal of the target substance in a more economical and/or efficient manner, and/or render the removal feasible, as compared to that using the capture medium or the process medium alone.

In various embodiments, the process medium comprises an aqueous solution comprising an ion having an electric charge opposite to that of the target ion, and which interacts with the target ion to form a compound in the process medium. In embodiments wherein the target ion is a negatively charged ion, for example, the ion contained in the process medium is a positively charged ion.

The process medium may be an aqueous solution comprising one or more of a hydrogen ion, a zinc ion, and a strontium ion. In various embodiments, the process medium is an aqueous solution comprising one or more of a zinc ion and a strontium ion.

In various embodiments, the process medium is an aqueous solution having a pH of less than 7, such as a pH of 6.5 or less, 6 or less, 5.5 or less, 5 or less, or be in the range from about 3 to about 6.8, about 5 to about 6.5 or about 5.5 to about 6.5.

As in the case for the capture medium, the process medium may comprise a chloride ion. In other words, either one or both the capture medium or the process medium may comprise a chloride ion. The chloride ion may be present for charge balancing purposes. Accordingly, the process medium may be an aqueous solution comprising one or more of hydrogen chloride, zinc chloride and strontium chloride, and which may be present in the process medium as H⁺ and Cl⁻, Zn²⁺ and Cl⁻, and Sr²⁺ and Cl⁻, respectively.

The target ion comprised in the capture medium may be transported to a process medium via an ion transport mechanism. In various embodiments, the ion transport mechanism comprises or consists of one or more selected from a selectively permeable ion exchange membrane system and an ion exchange resin system.

In addition to being adapted to allow transporting of the target ion comprised in the capture medium to a process medium, the ion transport mechanism may also be adapted to allow a flow of ions between the capture medium and the process medium to maintain charge balance in the capture medium and the process medium. The term “charge balance ion” may be used to describe such ions, and may include negative ions transported from process medium to capture medium, or positive ions moved from capture medium to process medium.

In various embodiments, transporting the target ion comprised in the capture medium to the process medium comprises providing a concentration gradient of the target ion in the direction from the capture medium to the process medium. Due to higher concentration of the target ions in the capture medium, the target ions may be moved across the ion transport mechanism by diffusion. Since the target ions are moved along the concentration gradient, additional energy such as application of electrical energy to apply an electrical potential to move the target ions are not necessary. Though optional, an electrical potential may additionally be applied across the ion transport mechanism to improve efficiency in transportation of the target ions.

Conversely, for charge balance ions, they may be moved either along the concentration gradient, such as when negative ions are being moved from the process medium to the capture medium, or against the concentration gradient, such as when positive ions are being moved from the capture medium to the process medium. When the charge balance ions are being moved along the concentration gradient, additional energy such as electrical energy to apply an electrical potential to move the charge balance ions may not be necessary, as in the case for target ions. Applying of additional energy such as electrical potential to move the charge balance ions may nevertheless be made to increase efficiency. In embodiments whereby the charge balance ions are moved against the concentration gradient, additional energy such as electrical energy to apply an electrical potential across the ion transportation mechanism may be used to move the charge balance ions.

In various embodiments, the flow of ions between the capture medium and process medium to maintain charge balance comprises one or more of a flow of a negative ion from the process medium to the capture medium, and a flow of a positive ion from the capture medium to the process medium.

In some embodiments, the flow of a negative ion from the process medium to the capture medium is carried out along a concentration gradient of the negative ion in the direction from the process medium to the capture medium.

In some embodiments, the flow of a positive ion from the capture medium to the process medium is carried out against a concentration gradient of the positive ion in the direction from the capture medium to the process medium. As mentioned above, additional energy may be applied to move an ion in a direction against its concentration gradient. Accordingly, the method may further comprise applying an electrical potential across the ion transport mechanism for flow of the positive ion from the capture medium to the process medium.

As mentioned above, the process medium may comprise an aqueous solution comprising an ion having an electric charge opposite to that of the target ion, and which interacts with the target ion to form a compound in the process medium. Concentration of the ion with an electric charge opposite to that of the target ion may be higher in the process medium than in the capture medium.

In some embodiments, the compound precipitates or aerates from the process medium. The compound may have a lower solubility in the process medium than in the capture medium. As such, the compound may be precipitated or be preferentially precipitated out from the process medium. Accordingly, possibility of precipitation of the compound in the capture medium may be minimised.

For example, the process medium may be an aqueous solution comprising zinc chloride (ZnCl₂). The zinc chloride may form Zn²⁺ and Cl⁻ in the process medium. When the target substance is CO₂, for example, the target ion may be CO₃²⁻. The CO₃²⁻ may react with Zn²⁺ in the process medium to form zinc carbonate (ZnCO₃), which is insoluble in the process medium, hence precipitates out from the process medium.

As a further example, the process medium may be an aqueous solution comprising strontium chloride (SrCl₂). The strontium chloride may form Sr²⁺ and Cl⁻ in the process medium. When the target substance is SO₂, for example, the target ion may be SO₄²⁻. The SO₄²⁻ may react with Sr²⁺ in the process medium to form strontium sulphate, which precipitates out from the process medium. When the target substance is CO₂, for example, the target ion may be CO₃²⁻. The CO₃²⁻ may react with Sn²⁺ in the process medium to form strontium carbonate (SnCO₃), which is insoluble in the process medium, hence precipitates out from the process medium.

Alternatively, or additionally, there may be low stability of the compound formed, such that the compound aerates or bubbles out of the process medium.

For example, the process medium may be an aqueous solution comprising hydrogen chloride (HCl). The hydrogen chloride may form H⁺ and Cl⁻ in the process medium. When the target substance is CO₂, for example, the target ion may be CO₃²⁻. The CO₃²⁻ may react with H⁺ in the process medium to form carbonic acid (H₂CO₃). While the carbonic acid may remain in solution initially, with further supply of CO₃²⁻ ions to the process medium, concentration of the carbonic acid may eventually increase beyond its solubility limit in the process medium. The excess carbonic acid may dissociate into water and CO₂, which aerates from the process medium as a CO₂ gas stream. Advantageously, the CO₂ gas stream may be a high purity CO₂ gas stream that can be commercially exploited.

In various embodiments, the process medium may be an acidic solution containing H⁺. When the target substance is SO₂, for example, the target ion may be SO₃²⁻ and/or SO₄²⁻. The SO₃²⁻ and/or SO₄²⁻ may react with H⁺ in the process medium to form sulphurous acid (H₂SO₃) and/or sulphuric acid (H₂SO₄). Advantageously, the H₂SO₄/H₂SO₃ acid solution may be a high molarity acid solution that can be commercially exploited.

The method may further comprise removing the compound from the process medium. Advantageously, in embodiments wherein the compound precipitates or aerates from the process medium, as the compound may exist in a different physical phase (solid or gas) as compared to the process medium (liquid), removal of the compound from the process medium may be carried out easily, such as via filtering of the precipitate or collecting of the gas.

To enhance ease of removal of the compound, the method may further comprise increasing concentration of the compound in the process medium and/or reducing amount of the target ion in the process medium, prior to removing the compound from the process medium.

Increasing concentration of the compound in the process medium may, for example, involve reducing amount of the aqueous solution in the process medium prior to removing the compound from the process medium.

In various embodiments, the method further comprises regenerating the capture medium and/or the process medium. Regenerating the process medium may, for example, involve treating the compound with heat, chemical and/or electrical energy to generate a gaseous stream comprising the target ion. Accordingly, in various embodiments, removing the compound from the process medium further comprises treating the compound with heat, chemical and/or electrical energy to generate a gaseous stream comprising the target ion.

Methods disclosed herein may be carried out in an apparatus for removing a target substance from a gas according to a second aspect.

The apparatus may comprise a capture medium comprising an alkaline aqueous solution for dissolving the target substance comprised in the gas to form a target ion in the capture medium. Examples of suitable capture medium and target substance have been discussed above.

For example, the alkaline aqueous solution may comprise one or more of a sodium ion, a potassium ion, a calcium ion, and a magnesium ion, while the target substance may comprise an acid anhydride. Examples of acid anhydride include carbon dioxide (CO₂) and sulphur dioxide (SO₂), as mentioned above.

The capture medium may be an alkaline aqueous solution having a pH of 9.5 or greater. As mentioned above, pH of the capture medium may depend on factors such as type of target substance and the gas used. When the target substance is CO₂ and the gas is pure CO₂, for example, pH of the capture medium may be 9.5 or greater. As another example, when the target substance is SO₂, pH of the capture medium may be 9.5 or greater, regardless of the type of gas the SO₂ is present in.

In some embodiments, when the target substance is CO₂ and the gas is air i.e. not in the form of pure CO₂, the capture medium may be an alkaline aqueous solution having a pH of 13.5 or greater.

The capture medium may be housed in a capture chamber. The capture chamber may comprise an inlet for receiving the capture medium and an outlet for discharging the capture medium housed in the capture chamber. In various embodiments, the capture chamber comprises a gas inlet for receiving the gas comprising the target substance. The gas comprising the target substance may be channelled into the capture medium, so that contact of the target substance with the capture medium may take place. The target substance may dissolve in the capture medium to form a target ion in the capture medium.

The apparatus disclosed herein may comprise a process medium comprising an aqueous solution having an ion with an electric charge opposite to that of the target ion, and which is adapted to interact with the target ion to form a compound in the process medium. Examples of suitable process medium have been discussed above.

The process medium may be an aqueous solution having a pH of less than 7, and/or be an aqueous solution comprising one or more of a hydrogen ion, a zinc ion, and a strontium ion. Specific examples of the process medium include an aqueous solution comprising one or more of hydrogen chloride, zinc chloride and strontium chloride. Either one, or both the capture medium and the process medium may comprise a chloride ion. Concentration of the ion with an electric charge opposite to that of the target ion may be higher in the process medium than in the capture medium.

An ion transport mechanism adapted to allow transport of the target ion from the capture medium to the process medium, and a flow of ions between the capture medium and the process medium to maintain charge balance may be comprised in the apparatus. Suitable ion transport mechanisms have been discussed above. In various embodiments, the ion transport mechanism comprises or consists of one or more selected from a selectively permeable ion exchange membrane system and an ion exchange resin system.

As mentioned above, a compound may be formed due to interaction with the target ion with an ion having an electric charge opposite to that of the target ion in the process medium, and which may be precipitated or aerated from the process medium.

In various embodiments, the compound may have a lower solubility in the process medium than in the capture medium. As such, the compound may be precipitated or be preferentially precipitated out from the process medium. Accordingly, possibility of precipitation of the compound in the capture medium may be minimised.

The process medium may be housed in a process chamber. The process chamber may comprise a gas capturing module adapted to remove or to contain the compound aerated from the process medium. Additionally or alternatively, the process chamber comprises an extraction module adapted to remove the compound precipitated from the process medium and/or aqueous solution from the process medium. As mentioned above, aqueous solution may be removed from the process medium to enhance ease of removal of the compound.

One or more extraction modules may be present in the apparatus. For example, a single extraction module may be present in the apparatus to remove the compound precipitated from the process medium, as well as to remove aqueous solution from the process medium. In various embodiments, a plurality of extraction modules are present, with separate extraction modules being used to remove the compound precipitated from the process medium, and aqueous solution from the process medium. For example, the plurality of extraction modules may comprise a filter and a dryer or distillation unit. By passing the process medium through the filter and the dryer or distillation unit, the compound precipitated from the process medium may be removed by the filter, whereas the aqueous solution may be removed from the process medium by the dryer or distillation unit.

In further embodiments, an extraction module configured to unclog the ion transport mechanism by extracting the salts precipitated on the ion transport mechanism or the gas bubbles sticking onto the ion transport mechanism may be present. An extraction module may also be configured to extract target ions from process medium to reduce concentration of the target ions in the process medium, and/or to extract cations that have flowed from the process medium to the capture medium to reduce concentration of the cations in the capture medium.

In some embodiments, the process chamber comprises a replenishing module adapted to supply one or more of the process medium, chemicals and water to the process chamber. Advantageously, this may allow continual operation of the process chamber, instead of having to take place via batch processing.

As mentioned above, the process medium may be regenerated. Regenerating the process medium may, for example, involve treating the compound with heat, chemical and/or electrical energy to generate a gaseous stream comprising the target ion. Accordingly, in various embodiments, the process chamber comprises a treatment module adapted to treat the process medium via heating, a chemical process, an electrical process, and/or an electrochemical process.

In some embodiments, the process medium may be regenerated by removing the compound precipitated from the process medium. For such purpose, the apparatus may further comprise a process medium regeneration chamber adapted to receive the compound precipitated from the process medium. The process medium regeneration chamber may be adapted to allow one or more of chemical treatment, heat treatment, and electrical treatment of the process medium to be carried out therein. Additionally or alternatively, the process chamber may be configured to function as a process medium regeneration chamber adapted to receive the compound precipitated from the process medium.

The methods and apparatus for removing a target substance from a gas disclosed herein may be used in treatment of industrial exhaust gas or air. As disclosed herein, various embodiments aim to capture such target ions in an economically viable manner, thus benefitting the planet and reducing maintenance costs in industrial processes.

In order that the invention may be readily understood and put into practical effect, particular embodiments will now be described by way of the following non-limiting examples.

### EXAMPLES

### Example 1: Method of Reducing Amount of a Target Substance from a Gas

As disclosed herein, a method for removing a target substance from a gas is provided. The method may comprise providing a capture medium comprising an alkaline aqueous solution for dissolving the target substance comprised in the gas to form a target ion in the capture medium, contacting the target substance comprised in the gas with the capture medium to form a target ion in the capture medium, and transporting the target ion comprised in the capture medium to a process medium via an ion transport mechanism, wherein the process medium comprises an aqueous solution comprising an ion having an electric charge opposite to that of the target ion, and which interacts with the target ion to form a compound in the process medium, wherein the ion transport mechanism is adapted to allow flow of ions between the capture medium and the process medium to maintain charge balance.

### Example 1.1: Capture Medium

The proposed method may include providing a capture medium that enables target gases or acidic target gases to dissolve and form a solution of target ions, where concentration of the target ions is either the same concentration or higher than when pure water is used as capture medium.

In various embodiments, the capture medium may comprise or consist of an alkaline aqueous solution having a pH value of at least 9.5. In some embodiments, the capture medium comprise an alkaline solution having a pH value of pH>9.5.

When water used for this purpose already contains some dissolved aqueous ions of the target gas, it may be treated with an alkali to raise the pH, so that pH value is pH≥9.5 before the water treated with alkali is used for the capture medium.

When such an alkaline aqueous ion solution is exposed to air containing target gases or is exposed to a source of target gases, the target gases dissolve to form a higher concentration aqueous solution of target ions, as compared to concentration of the target ions achieved when pure water is used as capture medium, whereby ions which were already present in the solution and the target ions now introduced into the solution form an aqueous salt solution. Concentration of the target ions that is thus achieved is either the same as or higher than concentration of target ions which is achieved when pure water is used as the capture medium.

The alkaline aqueous ion solution may be in the form of an alkaline aqueous solution of cations, and the target ions may be in the form of target anions. The cations already present in the solution and the target anions introduced into the solution together form an aqueous salt solution. Concentration of the target anions that is thus achieved is either the same as or higher than the concentration of target anions which is achieved when pure water is used as the capture medium.

### Example 1.2: Process Medium

A process medium may be provided, which may be housed in a process chamber. The process medium may comprise or consist of a highly soluble aqueous solution of pH<7.0, such that concentration of the charge-balancing negative or positive ions in the process medium is higher than the concentration of such ions in the capture medium.

Solubility of salts formed between the target ions and the positive ions in the process medium may be lower than solubility of the salts formed between the target ions and the positive ions in the capture medium, thereby minimising possibility of precipitation of the salts of target ions in the capture medium.

There may be low solubility of the salts formed between the target ions and the positive ions already present in the process medium, such that these salts precipitate out of the process medium. Alternatively, or additionally, there may be low stability of the compound formed between the target ions and the charge-balancing positive ions transported to the process medium, such that the target gas formed from the target ions aerates or bubbles out of the process medium. Alternatively, or additionally, the process medium containing the precipitate may be distilled to increase concentration of the precipitate before commercially exploiting the precipitate.

### Example 1.3: Ion Transport Mechanism

An ion transport mechanism may be provided to allow transport of the target ions (which may be formed by dissolving the acidic gases in the capture medium) from the capture medium to the process medium along concentration gradient of the target ions (higher concentration of target ions in capture medium, lower concentration of target ions in process medium). In some embodiments, the target ions are target anions. Along with the above, charge balancing negative ions from the process medium may be transported to the capture medium, or charge balancing positive ions from the capture medium may be transported to the process medium, so as to maintain charge balance in the capture medium and the process medium.

The ion transport mechanism may, for example, be in the form of a selectively permeable ion exchange membrane system, an ion exchange resin system, or a combination of the above.

### Example 1.4: Extraction Mechanism

An extraction mechanism or module may be used to extract the precipitate from process medium and/or to collect the gas bubbled out of the process medium. Alternatively, or additionally, the extraction may extract undesired precipitates from the capture medium and/or the process medium, and/or extract the aqueous solution from the process chamber to distill it to reduce the water content, and/or unclog the ion transport mechanism by extracting the salts precipitated on the ion transport mechanism or the gas bubbles sticking onto the ion transport mechanism.

In some embodiments, the extraction mechanism or module may function to extract target anions from process medium to reduce concentration of the target anions in the process medium, and/or to extract cations that have flowed from the process medium to the capture medium to reduce the concentration of cations in the capture medium.

### Example 1.5: Regeneration Mechanism

Optionally, a regeneration mechanism may be provided. In some embodiments, the regeneration mechanism is provided. The regeneration mechanism may be provided to add heat, chemicals, or electrical energy to treat precipitates extracted from the process medium to generate a stream of the target gas, and/or treat the process medium to generate a stream of acidic gas, and/or regenerate the process medium and/or the capture medium.

### Example 1.6: Illustrative Advantages of Methods Disclosed Herein

When the target gases dissolve in the capture medium, concentration of target ions, such as target anions, in the capture medium increases. Moreover, pre-existing ions of the target gas, which may already be present in the source of water that is being used, may also be captured.

On the other hand, when the ion transport mechanism transports the target ions from the capture medium to the process medium, concentration of target ions in the capture medium may go down. These two processes can run in parallel or in batches. Thus, concentration of target ions can be maintained low in the capture medium so that more moles of target gases can dissolve in the capture medium.

The capture medium is very economical. It may be just alkali added to pure water or rainwater, readily available water containing pre-dissolved target ions, such as water found in natural water bodies, or water exposed to air in industrial processes such as cooling towers, etc. A pH of at least 9.5 may be maintained.

Energy used to expose water containing ions to air is also very low, since natural or industrial water exposed to air can be used as capture medium, thus not requiring additional input energy.

Energy used to expose pure water to air is also very low since pure water has a very high affinity to dissolve acidic gases. For example, rainwater is a readily available form of pure water exposed to air and contains dissolved target gases. This means that when pure water is allowed to be exposed to air containing target gases or a source of target gases, energy that is required is very low.

The ion transport mechanism is also economical since target ions flow from an initial high concentration to an initial low concentration according to methods disclosed herein. Thus, flow of target ions is in the direction of the concentration gradient, thus needing no, minimal, or reduced additional input electrical energy to drive the flow of ions. Optionally, the flow of target ions may be continued even when the flow inverts the concentration gradient; this would be at the expense of additional energy input such as electricity.

Generally, the precipitation process may be contained within the process medium and its associated equipment. The capture medium may be separated from the process medium by the ion transport mechanism. In so doing, the capture medium and associated equipment may experience minimal scaling or precipitation-related maintenance problems.

Since the inputs used in methods disclosed herein are low cost and the energy consumed is low, it may now become feasible that the extracted precipitates from process medium and/or the stream of gas and/or the by-products may already be valuable enough to recover costs of running the disclosed method.

As an example, when zinc chloride is used as the process medium for removal of carbon dioxide or when strontium chloride is used as the process medium for removal of sulphur dioxide, where negative charge balance ions move from process medium to capture medium, the zinc carbonate/strontium sulphate precipitate formed in the process medium is more expensive than the zinc chloride/strontium chloride consumed in the process medium. This allows creation of a potential net value addition when methods disclosed herein are used to capture CO₂/SO₂ gas from air/exhaust fumes, and/or when this proposed method is used to capture aqueous ions of these target gases from water.

Also, as an example, where positive charge balance ions move from capture medium to process medium, an acid of the target gas may be produced. The acid may dissociate to release pure gas bubbles out from the process medium with minimal, if any, net consumption of dissolved electrolytes used to treat the water used in the process medium or the capture medium. The only energy input may be electrical energy, which may be sourced renewably such as from a solar/wind power plant, without even needing any battery backup, thus reducing the input energy cost by saving the battery backup costs.

Since the process medium is separated from the capture medium, acidic solutions can be used as process medium, and alkaline solutions can be used as capture medium. As an example, zinc chloride or strontium chloride may be used in the process medium. As they form acidic aqueous solutions with water, they cannot be used to capture CO₂ from air directly. However, the aqueous solution of zinc chloride or strontium chloride can be used as a process medium, whereby aqueous ions of CO₂/SO₂ captured from a gas such as air in the alkaline capture medium may be physically transported via the ion transport mechanism to the process medium.

Since the precipitates are formed with heavier ions such as zinc, instead of lighter ions like sodium or calcium, heat energy needed to decompose the precipitates to generate a stream of gas is also lower than the energy consumed in the decomposition of precipitates formed with lighter ions like sodium or calcium. For example, zinc carbonate decomposes at low temperatures between 150 degrees Celsius to 400 degrees Celsius, which is available naturally as concentrated solar heat or as waste industrial heat.

### Example 2: Apparatus for the Proposed Method

As disclosed herein, an apparatus for removing a target substance from a gas is provided. The apparatus may comprise a capture medium comprising an alkaline aqueous solution for dissolving the target substance comprised in the gas to form a target ion in the capture medium, a process medium comprising an aqueous solution having an ion with an electric charge opposite to that of the target ion, and which interacts with the target ion to form a compound in the process medium, and an ion transport mechanism adapted to allow flow of the target ion from the capture medium to the process medium, and flow of ions between the capture medium and the process medium to maintain charge balance.

### Example 2.1: Process Medium

The process medium may comprise or consist of an aqueous solution contained or housed in a process chamber.

In various embodiments, the target ions are target anions, and the process medium contain positive ions, such that (i) molar solubility of the salts of the target ions and the positive ions in the capture medium is significantly higher than the molar solubility of the salts of the target ions and the positive ions in the process medium to ensure that concentration of the target ions in the capture medium is maintained higher than the concentration of target ions in the process medium, and to ensure the salts formed between the target ions and the positive ions in the process medium either precipitate out of the process medium or dissociate to release a gas stream from the process medium, and/or (ii) concentration of the charge-balancing positive ions is significantly higher in the process medium than in the capture medium.

The process medium may be in the form of an aqueous solution of negative ions, which form highly soluble salts with the positive ions present in the process medium, and those transported from the capture medium, such that concentration of such negative ions is low in the capture medium but high in the process medium.

### Example 2.2: Process Chamber

The process chamber may or may not be airtight to allow for easy access for maintenance. Additionally, or alternatively, the process chamber may have a gas capturing module to capture the stream of gas being released from the process medium, and/or may have a precipitate extraction mechanism to extract precipitate containing target ions, whereby the extracted precipitate may be used for desired purposes or may undergo chemical, thermal, or electrochemical treatment to release a stream of gas and to regenerate the process medium.

Additionally, or alternatively, the process chamber may have a replenishing module to replenish the process medium, and/or may have an associated treatment module to treat the process medium thermally or chemically, or electrochemically by adding heat, chemicals, or electricity to the process chamber.

Additionally, or alternatively, the process chamber may have an extraction module to extract the liberated gas and/or other treatment products, such as excess water, and/or may have an additional module to add chemicals or remove by-products, such as to remove excess water or to top up the water.

### Example 2.3: Capture Medium

The capture medium may be contained or housed in a capture chamber.

The capture medium may be alkalised pure water at a pH of at least 9.5, or pH>9.5, that can be exposed to a source of acidic gases, such as air or exhaust fumes within the capture chamber to capture the acidic gases to form dissolved ions herein referred to as target ions.

The capture medium may also be alkalised pure water at a pH of at least 9.5, or at pH>9.5 that has already been exposed to a source of acidic gases, such as air or exhaust fumes, before entering the capture chamber. For example, this may include rainwater that already contains dissolved acidic gases present in the air; pure water that is allowed to be exposed to a source of acidic gases, such as air or exhaust fumes, to dissolve them to form target ions in the capture medium.

The capture medium may be an alkaline water solution at pH≥9.5 that can be exposed to air to capture target gases after its pH has been raised to pH≥9.5. The capture medium may be water from natural or industrial sources that may already contain aqueous ions of the target gases, whereby its pH is raised to pH≥9.5 by adding alkali to such water.

The ions, if any, may be present in the capture medium, and may form highly soluble salts with the target ions and charge balancing ions to prevent precipitation of sacrificial ions in capture medium before brine is formed in the capture medium. The term “brine” as used herein refers to a solution of sodium chloride (NaCl) at a concentration of at least 50% as compared to maximum solubility limit. Taking capture medium of sodium chloride and process medium of zinc chloride for example, molar solubility of zinc chloride is higher than molar solubility of sodium chloride. When chloride ions are moved from process medium to capture medium, they move from a high solubility solution to a low solubility solution. When solubility limit in the capture medium is reached, brine of sodium chloride is formed in the capture medium. Theoretically, moving more chloride ions from process medium to capture medium leads to precipitation of sodium chloride in the capture medium. In practice, removal of the target substance from the gas using a method and apparatus disclosed herein may be stopped before maximum solubility threshold of sodium chloride is reached, for example, when brine is formed. Upon formation of the brine, the process may be stopped so that the brine may be drawn out, and replenishing with fresh capture medium.

Minimum pH of the capture medium may be maintained at 9.5, or more than 9.5, which may be inversely proportional to the concentration or partial pressure of the acidic gas to be captured into the capture medium. For instance, if pure CO₂ is to be captured, then pH 9.5 may be sufficient. However, if CO₂ is being directly captured from the air, then the minimum pH may be maintained above pH value of 13.5 for efficient capture of the CO₂.

### Example 2.4: Capture Chamber

As mentioned above, the capture medium may be contained in a capture chamber. The capture chamber may have a liquid input module to let in capture medium that is already exposed to air and a liquid output module to let out capture medium from which some of the target ions (ions formed by dissolving acidic gas in capture medium) have been removed, or the charge balance ions (negative ions transported from process medium to capture medium, or positive ions moved from capture medium to process medium) have been added or removed,

The capture chamber may have a gas input module to let in air/source of the target gases to create an interface between air/target gases and capture medium. The capture chamber may allow acidic target gases to be dissolved or captured into the capture medium, and may further house an ion transport mechanism to transfer target ions from the capture medium to process medium, and to transfer charge balancing ions from process medium to capture medium or vice versa.

As in the case for the process chamber, the capture chamber may or may not be airtight to allow easy access for maintenance.

### Example 2.5: Ion Transport Mechanism

The ion transport mechanism may be a selectively permeable membrane to allow diffusion of ions across the membrane due to concentration gradient across the membrane. In some embodiments, this may be combined with force of electrical potential applied across the membrane, to (i) allow target ions to diffuse from the capture medium to the process medium, and/or (ii) allow negative charge balance ions to diffuse from the process medium to the capture medium, and/or (iii) allow positive charge balance ions to diffuse from capture medium to process medium.

The ion transport mechanism may be a single selective membrane or may be multiple membranes, each one focused on specific ions to be diffused, or each one focused on diffusion in specific directions, or any combinations.

The ion transport mechanism may be in the form of ion exchange resin to (i) pick up target ions from capture medium to release in process medium, and/or (ii) pick up negative charge balance ions from process medium and release them in capture medium, and/or (iii) pick up positive charge balance ions from capture medium and release them in the process medium.

The ion transport mechanism may be a single ion exchange resin to move all the ions, or may be multiple ion exchange resins, each one focused on specific ions to be picked up and released, or each one focused on pick up and release in a specific direction, or any combinations, whereby the combination of selectively permeable ion exchange membrane or ion exchange resin may also be used.

The ion transport mechanism may be shut down or may use additional external energy input when concentration of the negative charge balance ions in the capture medium exceeds the solubility limit.

The ion transport mechanism may be in fluid communication with the capture medium and the process medium, and may be placed between the capture medium and process medium. It may consist of at least a portion of one or more ion exchange membranes/resins in contact with the capture medium and the process medium. The ion exchange membrane portions may allow diffusion of negative charge balance ions from process medium to capture medium, diffusion of positive charge balance ions from capture medium to process medium, and diffusion of target ions from capture medium to process medium.

The ion transport mechanism may involve a mechanism to flush the ion exchange resin alternately with capture medium and process medium. For example, ion exchange resins may be able to pick up ions of a specific type when exposed to a process medium and release these ions into capture medium, and vice versa.

The ion transport mechanism may involve a mechanism to dip the ion exchange resin alternately in capture medium and process medium. In embodiments wherein the ion transport mechanism comprises or consists of an ion exchange resin, the ion exchange resin may be able to pick up ions of a specific type when exposed to a process medium and release these ions into capture medium, and vice versa.

Electrical energy may be used to ensure specific ions diffuse in specific directions using the ion exchange membranes/resins.

### Example 2.6: Process Medium Regeneration Chamber

The process medium regeneration chamber may be adapted to receive precipitates of target ions or aqueous solutions containing target ions from the process chamber.

The process medium regeneration chamber may allow chemical treatment to release target gas and regenerate the process medium, and/or allow heat treatment to release target gas and generate oxides which may be commercially exploited or may be further reused to regenerate the process medium, and/or allow electrical treatment to release gas and regenerate the alkali and acid that goes back to the process medium/capture medium.

In some embodiments, the process chamber may be adapted with features of the process medium regeneration chamber, so that the process chamber can itself act as a process medium regeneration chamber, where applicable.

### Example 3: Working Mechanism

A) Negative Charge Balancing Ion Diffusion from Process Medium to Capture Medium

The process medium may comprise or consist of an aqueous negative charge balancing ion salt solution, such as zinc chloride/strontium chloride, with pH<7.0.

In the starting state, the charge balancing ion concentration in the process medium may be higher than in the capture medium. Also, an electrical potential may be applied across the ion transport mechanism.

Due to the combined effects of the concentration gradient across the ion transport mechanism and the electrical potential, the negative charge balancing ions may move from the process medium to the capture medium.

As the negative charge balancing ions continue to move from process medium to capture medium, concentration of the negative charge balancing ions in process medium may decrease. In contrast, concentration of negative charge balancing ions in the capture medium may increase.

The diffusion of negative charge balancing ions from process medium to capture medium via the ion transport mechanism may be stopped when their concentration exceeds the solubility limit in the capture medium or exceeds the concentration in the process medium. If additional flow is desired, this may still be continued at the expense of additional electricity.

B) Positive Charge Balancing Ion Diffusion from Capture Medium to Process Medium

The process medium may comprise or consist of an aqueous solution with pH<7.0.

In the starting state, the positive charge balancing ion concentration in the process medium may be higher than in the capture medium. Also, an electrical potential may be applied across the ion transport mechanism.

Due to combined effects of the concentration gradient across the ion transport mechanism and the electrical potential, the positive charge balancing ions may move from the capture medium to the process medium.

As the positive charge balancing ions continue to move from the capture medium to process medium, concentration of the positive charge balancing ions may remain constant in both process medium and capture medium.

For the capture medium, every time a few ions of target gas are dissolved into the capture medium, negative target ions may be formed, and positive charge-balancing ions may be produced. An example reaction may be CO₂+H₂O=2H⁺+CO₃²⁻; at pH≥9.5.

For the process medium, every time the few ions of charge balancing ions are moved over to the process medium, they may recombine with the negative target ions to bubble out the gas. An example reaction may be 2H⁺+CO₃²⁻=CO₂+H₂O; at pH<7.0.

C) Target Ion Diffusion from Capture Medium to Process Medium

The capture medium can gain target ions by dissolving more target gas into it, and concentration of target ions in the capture medium may depend on pH of the capture medium and solubility of the salt formed between the target ion and the positive ions in the capture medium. The pH may be maintained at a value of at least 9.5 or higher depending on the partial pressure of the acidic gas from which the target ions are to be captured.

### D) Concentration Gradient Development Between Capture Medium and Process Medium

Concentration of target ions in the capture medium may be more than concentration of target ions in the process medium, due to lower solubility of target ion salt in the process medium than in the capture medium.

A target ion salt may be used in the process medium with lower solubility than the target ion salt in the capture medium, so that the target ion salt precipitates in the process medium before the target ion salt precipitates in the capture medium.

Accordingly, the target ions may diffuse via the ion transport mechanism along the concentration gradient aided with electrical potential applied across the ion transport mechanism to the extent that such electrical potential is necessary.

### E) Change in pH of Capture Medium

Target ions may get replaced by negative charge balancing ions, or the target ions may be recombined with the positive charge balancing ions. When replaced by negative charge balancing ions, pH of the process medium drops, which may be replenished by adding more acid/acidic salt in the process medium. For instance, chloride ions may be replaced by carbonate ions; the carbonate ions precipitate in the form of zinc carbonate, so the concentration of zinc chloride in the process medium drops. Some zinc chloride may be added to replenish the zinc chloride concentration in the process medium, so as to maintain pH>7.0 in the capture medium.

Taking a process medium of zinc chloride, for example, a fully concentrated zinc chloride solution may have a pH of about 1.0, while a dilute zinc chloride solution may have a pH that is closer to 7.0, while still being less than 7. Depending on the intended application such as target substance to be removed, pH of the process medium may be maintained anywhere in the pH<7.0 range, such as less than pH 4.2, or above pH 5.5 and below 6.5. To reduce the pH, more zinc chloride may be added to the process medium.

As a further example, a fully concentrated solution of strontium chloride has pH of about 6.5, whereas a dilute strontium chloride solution has a pH that is closer to 7.0 but nevertheless still less than 7.0. Accordingly, operating range of a process medium comprising strontium chloride may be in the range of pH 6.5 to a value greater than pH 6.5 and less than 7.0. Therefore, if such an operating range is desired, strontium chloride may be used instead of zinc chloride as the process medium when the target substance is carbon dioxide, so that strontium carbonate may be precipitated.

When recombined with positive charge balancing ions, the pH drops as the process medium becomes more acidic.

A controlling device based on pH or ion concentration readings may also be used to stop the diffusion when the pH drops or increases beyond the desired range or to top up the salts to maintain the pH levels in the required range.

### F) Prevention of Precipitation of Target Ions in Capture Medium (for Negative Charge Balancing Ion Flow Mechanism)

The captured medium may be exposed to a source of target gases and contains target ions. Solubility of salts of target ions with the ions present in the capture medium may be more than the solubility of the salts of the target ions of the ions present in the capture medium.

Concentration of the target ions in the capture medium may be in equilibrium with the target gases exposed to the capture medium. Still, concentration of the target ions in the process medium may be limited by solubility of the salts of the target ions and the ions present in the process medium.

Thus, if solubility of the salts of the target ions and the ions present in the process medium is lower than the concentration of the target ions maintained in the capture medium, the capture medium can continue to acquire more target ions from the gas exposed to the capture medium.

The target ions may continue to migrate to the process medium via the ion transport mechanism, and the target ions may continue to precipitate out of the process medium without any precipitation in the capture medium, until concentration of the charge-balancing ions equalises between the process medium and the capture medium or exceeds the solubility limit in the capture medium, whereupon the flow of ions via the ion transport mechanism is stopped and the capture medium is replenished.

Also, incoming water from the nature of the industrial process may be pre-treated to remove calcium and magnesium to prevent precipitation in the capture medium and to allow a soluble carbonate salt to be used in the process medium.

### Example 4: Need for CO₂ Capture

The Earth's oceans and atmosphere can be considered a huge chemical system in equilibrium. It has been established that pH of the ocean has been locked in at 8.1, which is equivalent to an H₃O⁺ concentration of 10^{-8.1} mol/L or 0.0000000079 mol/L. Historically (think Pre-Industrial Age), the earth's atmosphere has had a CO₂ concentration hovering around 280 parts per million (ppm). Beginning in the late 1950s, consistent records of the concentration of CO₂ have been kept, and a steady, consistent increase has been observed. Today this value stands at 400 ppm. The incremental CO₂ in the atmosphere has caused a shift in the equilibrium state and reduced pH of the ocean. That change ranges from 0.1 to 0.2 pH units, all in the downward direction so that today pH of most oceans ranges from 8.0 to 7.9. The explanation is that the increase in CO₂ causes more CO₂ to be dissolved in the ocean which causes more carbonic acid to form, which increases the amount of H₃O⁺, which causes a change in pH in the downward direction. This results in Ocean Acidification, which leads to the dissolution of carbonates that harm marine life.

### Example 5: Methods of CO₂ Capture and Problems

CO₂ can be captured from ambient air, water, or concentrated CO₂ exhaust gases produced by burning fossil fuels or other industrial processes.

While capturing carbon dioxide from the industrial exhaust is good since it reduces the addition of CO₂ to the air, it does not remove CO₂ which has already been added into the air. Moreover, due to the highly concentrated nature of CO₂ gas in such exhausts, it is easier to capture CO₂ from them rather than from ambient air or ambient water.

Hence, ambient CO₂ capture systems are more expensive. Also, the systems suffer from scaling as a significant amount of water is evaporated due to evaporation, thus increasing the concentration of ions. Hence, an efficient CO₂ capture method to directly capture CO₂ from the air is keenly desired and has valuable industrial applications.

### Example 6: Science for Carbonate Precipitation

Distilled water has no dissolved ions. Water is H₂O. There is a balance between H⁺, OH⁻, and H₃O⁺, so water is neither acidic nor alkaline. Hence, pH of distilled water is 7.

When distilled water is exposed to air, the CO₂ from the air dissolves in water, the CO₂ mixes with water and creates the following pH buffer system:

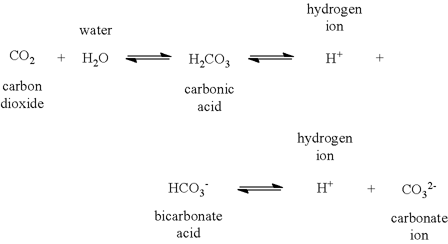

Since there are no dissolved ions in distilled water, the pH shifts from pH=7 toward pH=5.5 due to solution of CO₂ in water, creating carbonic acid which is a weak acid.

However, when ions such as sodium, calcium, magnesium etc., are dissolved in water, the hydroxides of these ions are strong alkalis. They may react with carbonic acid, a weak acid, thus forming weak basic bicarbonates and carbonates. Hence, pH of the water may shift from pH=7, towards pH=8 and pH=9.

The chlorides of these salts may be highly soluble in water, but the bicarbonates and carbonates have lower solubilities in water. Hence, when water is evaporated at alkaline pH, carbonate deposits may be formed. Thus, existing systems that capture CO₂ from air suffer from scaling, which can be overcome substantially based on embodiments disclosed herein.

### Example 7: Design Factors

In various embodiments, the positive ion of the capture medium should be such that negative target ion should be highly soluble in the capture medium. For example, positive ions of sodium, calcium, and magnesium form highly soluble salts with the negative ions of CO₂ and SO₂.

In various embodiments, the positive ion of the process medium should be such that the negative target ion should form a precipitate in the process medium. For example, the positive ion of zinc forms a precipitate of ZnCO₃ when combined with the negative ion of CO₂. As another example, the positive ion of strontium forms a precipitate of SrSO₃ when combined with the negative ion of SO₂.

In various embodiments, the charge balancing ion, which is negative in charge, should be such that it is present in low concentration in the capture medium in the initial state but should be highly soluble in the capture medium and the process medium.

Taking chlorine for example, it is typically present in low to medium concentrations in most natural and industrial exhaust water sources; very rarely is chlorine brine discharged. Chlorine may form highly soluble salts with positive ions of sodium, calcium, and magnesium, and forms highly soluble salts with positive ions of zinc, and strontium.

In various embodiments, the cost of salt that provides a charge balancing ion, which is negative in charge, should be lower than that of the precipitate that helps extract the target ion. For example, zinc chloride is cheaper than zinc carbonate, and strontium chloride is cheaper than strontium sulphate.

In various embodiments, toxic chemicals such as salts of lead are avoided. Zinc, strontium, sodium, potassium, calcium, and magnesium salts with chlorine, carbonate, bicarbonate, and sulphate are non-toxic hence able to fulfil the above condition.

### Example 8: Direct Capture of CO₂ or SO₂ from Air/Smoke, Including Pre-Dissolved Aqueous Ions of CO₂ and SO₂

### A) Produce Zinc Carbonate Precipitate

Where water pre-exposed to CO₂ was used, the water was alkalized to bring its pH value to pH≥9.5 to convert aqueous bicarbonate ions to carbonate ions. The alkalized water, or termed herein as alkaline aqueous solution, acted as the capture medium. CO₂ was captured in the capture medium (alkaline aqueous solution, pH≥9.5). The carbonate ions from capture medium was transported over to process medium, formed of zinc chloride aqueous solution with pH<7.0, contained in a process chamber. Zinc carbonate precipitate was generated as the output in the process chamber. The chloride ions were transported from process medium to capture medium to form aqueous sodium chloride (by-product).

If CO₂ is captured from a very dilute source like air, the capture medium may be maintained at a pH value of pH≥13.5.

If CO₂ is captured from a more concentrated source, then less pH is required. For example, if CO₂ is captured from 100% pure CO₂ gas, then pH of 9.5 may be the minimum pH for use.

### B) Produce Strontium Sulphate Precipitate

When water containing pre-existing sulphate ions were used, the water was alkalized to bring its pH value to pH≥9.5 to neutralise all acids and acidic salts. The alkalized water, or termed herein as alkaline aqueous solution, acted as the capture medium. SO₂ was captured in the capture medium (alkaline aqueous solution, pH≥9.5). The sulphate/sulphite ions from capture medium was transported over to process medium, formed of strontium chloride aqueous solution with pH<7.0, contained in the process chamber. Strontium sulphate/sulphite precipitate were generated in the process chamber. The chloride ions were transported from process medium to capture medium to form aqueous sodium chloride (by-product).

C) Produce H₂CO₃ i.e., Produce CO₂ Gas

Where water pre-exposed to CO₂ was used, the water was alkalized to bring its pH value to pH≥9.5 to convert aqueous bicarbonate ions to carbonate ions. The alkalized water, or termed herein as alkaline aqueous solution, acted as the capture medium. CO₂ was captured in the capture medium (alkaline aqueous solution, pH≥9.5). The carbonate ions from capture medium was transported over to process medium, which is an acidic aqueous solution of pH<7.0, contained in a process chamber. Hydrogen carbonate (H₂CO₃), which dissociates to release pure CO₂ gas, was generated as output in the process chamber. The H⁺ ions were transported from capture medium to process medium to replenish the H⁺ ions in process medium.

If CO₂ is captured from a very dilute source like air, the capture medium may be maintained at a pH value of pH≥13.5. If CO₂ is captured from a more concentrated source, then less pH is required. For example, if CO₂ is captured from 100% pure CO₂ gas, then pH of 9.5 may be the minimum pH for use.

D) Produce H₂SO₄

When water containing pre-existing sulphate ions is used, the water was alkalized to bring its pH value to pH≥9.5 to neutralise all acids and acidic salts. The alkalized water, or termed herein as alkaline aqueous solution, acted as the capture medium. SO₂ was captured in the capture medium (alkaline aqueous solution, pH≥9.5). The sulphate/sulphite ions were transported from capture medium to process medium, which is an acidic aqueous solution of pH<7.0, contained in a process chamber. Sulphuric/sulphurous acid (H₂SO₄/H₂SO₃) were generated as the output in the process chamber. The H⁺ ions were transported from capture medium to process medium to replenish the H⁺ ions in process medium.

TABLE 1 provides a brief summary of selected features and non-limiting examples of methods and apparatus disclosed herein for embodiments relating to CO₂ capture from air or smoke or pre-concentrated CO₂ to produce zinc carbonate precipitate.

TABLE 1
Brief summary of selected features and non-limiting examples

| | Non- | |
|---|---|---|
| | limiting | |
| Feature | example | Description |
| Target | CO₂ | It may be from the CO₂ in the air, industrial |
| substance | | smoke, and/or pre-concentrated CO₂. |
| Capture | Alkaline | Minimum pH of the solution is inversely |
| medium | (sodium | proportional to the concentration of the |
| | hydroxide) | source of CO₂ used. |
| | solution | E.g., pH may be maintained at least 13.5 if |
| | with pH | CO₂ from the air is being directly captured, |
| | ≥9.5 | and maintained at least 9.5 if pre- |
| | | concentrated CO₂ is being captured. |
| | | If the pH is lower than the minimum pH, |
| | | alkali (such as sodium hydroxide) may be |
| | | added to increase the pH above the |
| | | minimum pH. |
| Capture | Water | When the pH of the water source is adjusted |
| medium | used for | to pH ≥9.5, most of the dissolved CO₂ is |
| (when | capture | converted to carbonate ions, which adds to |
| capture | medium | the carbonate ions being produced by |
| medium | already | capturing CO₂ from the source of CO₂ used |
| already | has some | in this process. Also, undesirable insoluble |
| contains | dissolved | hydroxides are removed due to precipitations. |
| dissolved | CO₂ | E.g., Adding NaOH to seawater produces |
| CO₂) | | 0.0025 molar carbonate ion solution; this is |
| | | already more than the 0.000007 molar |
| | | concentration of the carbonate ions in the |
| | | process medium. |
| Target ion | carbonate | pH of the capture medium should be more |
| | ions (bi- | than 9.5 so that dissolution of CO₂ produces |
| | carbonate | more carbonate ions than bicarbonate ions. |
| | ions | At pH less than 9.5, more bicarbonate ions |
| | cannot | are produced instead of carbonate ions, which |
| | be used) | reduces efficiency. Hence, if the pH is below |
| | | 9.5, some alkali (such as sodium hydroxide) |
| | | should be added to increase pH above 9.5 |
| Process | Zinc | Diluted or concentrated zinc chloride |
| medium | chloride | solution with pH <7.0 may be used. If pH |
| | solution | >7.0, some zinc chloride may be added to |
| | with pH | reduce the pH below 7.0. |
| | <7.0 | Advantageously, methods disclosed herein |
| | | are able to produce zinc carbonate efficiently, |
| | | even when a high concentration of zinc |
| | | chloride such as concentrated zinc chloride is |
| | | used. |
| Ion | Transport | Concentration gradient (high concentration in |
| Transport | of | Capture Medium to low concentration in |
| Mechanism | carbonate | Process Medium) forms the primary |
| (for target | Ion from | mechanism. Electrical potential may |
| ion)— | capture | additionally be used to make the ions move. |
| Primary Ion | medium | Advantageously, a lower electrical potential |
| Transport | to | may be used since it is in the direction of the |
| Mechanism | process | concentration gradient, as compared to cases |
| | medium | whereby more electrical charge is required |
| | | when the movement is against the gradient. |
| Ion | Chloride | Along the concentration gradient (high |
| Transport | ion from | concentration in process medium to low |
| Mechanism | process | concentration in capture medium). Electrical |
| (for charge | medium | potential may be applied to make the ions |
| balancing | to | move. Advantageously, since it is in the |
| ion) | capture | direction of the concentration gradient, less |
| | medium | electrical potential may be used, as compared |
| | | to cases whereby more electrical charge is |
| Charge | Chloride | required when the movement is against the |
| Balancing | ion | gradient. |
| Ion | | Movement of charge balancing ion maintains |
| | | electrical balance and reduces electricity |
| | | consumption. Since flow of electrons |
| | | between anode and cathode is not used in this |
| | | system to balance the charge, less electricity |
| | | is used. |
| | | If zinc chloride is used as the process |
| | | medium, carbonate ion as the target ion and |
| | | chloride ion as the charge balancing ion, two |
| | | chloride ions may be removed from the |
| | | process medium every time one carbonate ion |
| | | moves to the process medium. This makes |
| | | one zinc ion available to combine with the |
| | | carbonate ion to form zinc carbonate. (Zn²⁺ + |
| | | CO₃²⁻═ZnCO₃) This enables formation of |
| | | zinc carbonate even at high concentrations of |
| | | zinc chloride. |
| | | When concentration of zinc carbonate |
| | | increases beyond solubility limit, excess zinc |
| | | carbonate precipitates out of the process |
| | | medium as a carbonate deposit. |
| Compound/ | Zinc | This is a high-purity carbonate precipitate |
| Output | carbonate | that may be commercially exploited. |
| | precipitate | |
| Concen- | Solubility | Solubility of zinc chloride in water is approx. |
| tration | of zinc | 31 Molar, while solubility of sodium chloride |
| gradient | chloride > | in water is approx. 6 Molar. As such, chloride |
| of charge | solubility | ions are more concentrated in process |
| balancing | of sodium | medium than in capture medium. Chloride |
| Ion | chloride | ions move along the concentration gradient |
| | | from high concentration in process medium |
| | | to low concentration in capture medium |
| Concen- | Solubility | Solubility of sodium carbonate in water is |
| tration | of sodium | approx. 2 Molar, while solubility of zinc |
| gradient | carbonate > | carbonate in water is approx. 0.000007 |
| of | solubility | Molar. As such, carbonate ions are more |
| target ion | of zinc | concentrated in capture medium than in |
| | carbonate | process medium. |
| Over- | The | Along with desired movement of target ion |
| coming | inefficiency | (eg. carbonate ion), some hydroxide ions may |
| the | of | also move from capture medium to process |
| Practical | Carbonate | medium, which is undesirable. The |
| Inefficiency | Ion | hydroxide ions may combine with zinc ions |
| of the | Transfer | present in the process medium to form a |
| primary ion | | precipitate of zinc hydroxide salt, which may |
| transfer | | result in decrease in efficiency. Nevertheless, |
| mechanism | | the system may not be negatively impacted, |
| | | since any unwanted OH— transfer may simply |
| | | be precipitated away as zinc hydroxideand |
| | | the zinc hydroxide precipitate can be treated |
| | | to recover zinc oxide (by heat) or zinc |
| | | chloride by chemical treatment, which can be |
| | | carried out by adding HCl to zinc hydroxide. |
| | | Removal of zinc ions does not impact ionic |
| | | balance between zinc ions and chloride ions |
| | | in the process medium, since there is also |
| | | removal of chloride ions due to charge |
| | | balancing mechanism disclosed herein. |
| | | State of the art carbonate ion transport |
| | | technology is not very efficient; hence, other |
| | | systems cannot use it viably, but methods |
| | | disclosed herein can successfully overcome |
| | | the impact of the inefficiency. |
| Over- | The | Along with desired movement of chloride |
| coming | inefficiency | ions, some zinc ions may also move from |
| the | of | process medium to capture medium which is |
| Practical | Chloride | undesirable. These zinc ions may combine |
| inefficiency | ion | with hydroxide and carbonate ions in the |
| of the | transfer | capture medium to form a precipitate of zinc |
| charge- | | carbonate and zinc hydroxide salts. As such, |
| balancing | | these zinc ions do not remain dissolved in the |
| ion | | capture medium and does not interfere with |
| transport | | CO₂ capture process into process medium. |
| mechanism | | Advantageously, in methods and apparatus |
| | | disclosed herein, the unwanted zinc ions do |
| | | not thwart the ability of CO₂ to dissolve in a |
| | | water solution by making the solution highly |
| | | acidic. |
| Optional | Improve | Highly selective/highly efficient ion |
| improve- | efficiency | transport mechanisms may be used as and |
| ment | | when they become available in future; the |
| features | | system can work with the existing inefficient |
| | | ion transport mechanisms. |
| Optional | Ion | Unclogging methods such as ultrasonic |
| features | Transport | vibrators or polarity reversals may prevent |
| | Unclogging | the precipitates from scaling or clogging the |
| | | ion transport mechanism. |

TABLE 2 provides a brief summary of selected features and non-limiting examples of methods and apparatus disclosed herein for embodiments relating to SO₂ capture from air/smoke/pre-concentrated SO₂ to form sulphate/sulphite deposits.

TABLE 2
Brief summary of selected features and non-limiting examples
of methods and apparatus disclosed herein for
embodiments relating to SO₂ capture from air/smoke/pre-
concentrated SO₂ to form sulphate/sulphite deposits.

| | Non- | |
|---|---|---|
| | limiting | |
| Feature | example | Description |
| Target | SO₂ | It may be SO₂ from air, industrial smoke, or |
| substance | | pre-concentrated SO₂. |
| Capture | Alkaline | Minimum pH of the solution may be at least |
| medium | (sodium | 9.5, so there is excess unreacted alkali to |
| | hydroxide) | capture more SO₂ after the captured SO₂ has |
| | solution | already reacted with some of the alkali |
| | with pH | present in the capture medium. |
| | ≥9.5 | If the pH is lower than the minimum pH, |
| | | alkali (sodium hydroxide) may be added to |
| | | increase the pH above the minimum pH. |
| Capture | Water | When the pH of the water is adjusted to pH |
| medium | used for | ≥9.5, this neutralises all the acidic salts to |
| (when | the capture | form aqueous ionic salts (sulphates or |
| capture | medium | sulphites) and removes undesirable insoluble |
| medium | already | hydroxides. |
| already | has | Example—Seawater produces 0.028 molar |
| contains | aqueous | sulphate ion solution. The solubility of |
| aqueous | SO₂ | strontium sulphate (process medium) is |
| SO₂ ions) | ions | 0.00053 mols per litre. Therefore, sulphate |
| | | concentration in the capture medium is more |
| | | than the sulphate concentration in the process |
| | | medium. |
| Target | Sulphate/ | pH of the capture medium should be ≥9.5 so |
| ion | Sulphite | that the dissolution of SO₂ produces sulphate/ |
| | ion | sulphite ions in an aqueous solution at a high |
| | | capture rate. |
| | | If pH is below 9.5, alkali (sodium hydroxide) |
| | | may be added to increase pH to ≥9.5 |
| Process | Strontium | This may be diluted or concentrated zinc |
| medium | chloride | chloride solution with pH <7.0. If the pH |
| | solution | >7.0, some strontium chloride may be added |
| | with pH | to reduce the pH below 7.0. |
| | <7.0 | Advantageously, methods disclosed herein |
| | | are able to efficiently produce strontium |
| | | sulphate using concentrated strontium |
| | | chloride, even when a high concentration of |
| | | strontium chloride such as concentrated |
| | | strontium chloride is used. |
| Ion | Sulphate/ | This is along the concentration gradient (high |
| transport | sulphite | concentration in capture medium to low |
| mechanism | ion | concentration in process medium). Electrical |
| (for target | from | potential may additionally be used to make the |
| ion)— | capture | ions move. Advantageously, a lower electrical |
| Primary | medium to | potential may be used since it is in the |
| Ion | process | direction of the concentration gradient, as |
| Transport | medium | compared to cases whereby more electrical |
| Mechanism | | charge is required when the movement is |
| | | against the gradient. |
| Ion | Chloride | This is along the concentration gradient (from |
| transport | Ion from | high concentration in process medium to low |
| mechanism | process | concentration in capture medium. Electrical |
| (for | medium | potential may be applied to make the ions |
| charge | to | move. Advantageously, since it is in the |
| balancing | capture | direction of the concentration gradient, less |
| ion) | medium | electrical potential may be used, as compared |
| | | to cases whereby more electrical charge is |
| | | required when the movement is against the |
| | | gradient. |
| Charge | Chloride | Movement of charge balancing ion maintains |
| Balancing | Ion | electrical balance and reduces electricity |
| Ion | | consumption. Since flow of electrons between |
| | | anode and cathode is not used in this system |
| | | to balance the charge, less electricity is used. |
| | | Also, this ensures that two chloride ions are |
| | | removed from the process medium every time |
| | | one sulphate/sulphite ion moves to the process |
| | | medium. This makes one strontium ion |
| | | available to combine with the sulphate/ |
| | | sulphite ion to form strontium sulphate/ |
| | | sulphite. (Sr²⁺ + SO₄²⁻═SrSO₄) This enables |
| | | formation of strontium sulphate/sulphite |
| | | even at high concentrations of strontium |
| | | chloride. |
| | | As the concentration of strontium sulphate/ |
| | | sulphite increases beyond the solubility limit, |
| | | the excess strontium sulphate/sulphite |
| | | precipitates out of the process medium as a |
| | | sulphate/sulphite deposit. |
| Compound/ | Strontium | This is a high-purity sulphate/sulphite |
| Output | Sulphate/ | precipitate that may be commercially |
| | Sulphite | exploited. |
| | precipitate | |
| Concen- | Solubility | The solubility of strontium chloride in water |
| tration | of | is approx. 4 Molar, while solubility of sodium |
| gradient | strontium | chloride in water is approx. 6 Molar. |
| of charge | chloride > | As such, chloride ions are always more |
| balancing | Solubility | concentrated in process medium than in the |
| ion | of | capture medium if the sodium chloride |
| | sodium | concentration in capture medium does not |
| | chloride | exceed 4.0 molar concentration. |
| | | Chloride ions move along the concentration |
| | | gradient from high concentration in process |
| | | medium to low concentration in capture |
| | | medium, until concentration of sodium |
| | | chloride in capture medium does not exceed |
| | | concentration of strontium chloride in process |
| | | medium. |
| | | The process may be stopped when sodium |
| | | chloride concentration in capture medium |
| | | exceeds concentration of strontium chloride |
| | | in process medium, or additional electrical |
| | | potential may be applied to continue the |
| | | process beyond this point. |
| Concen- | Solubility | Solubility of sodium sulphate/sulphite in |
| tration | of sodium | water is approx. 2.6 Molar, while solubility of |
| Gradient | sulphate > | Strontium Sulphate/Sulphite in water is |
| of | Solubility | approx. 0.000008 Molar. |
| target ion | of | As such, sulphate/sulphite ions are always |
| | Strontium | more concentrated in capture medium than |
| | Sulphate | process medium. |
| Over- | The | Along with the desired movement of sulphate/ |
| coming | inefficiency | sulphite ions, some unwanted hydroxide ions |
| practical | of sulphate/ | may also move from capture medium to |
| inefficiency | sulphite ion | process medium. These undesired hydroxide |
| of the ion | transfer | ions may combine with the strontium ions in |
| transfer | | the process medium to form strontium |
| mechanism | | hydroxide, a moderately soluble ionic salt |
| of target | | (>10 grams/litre). So, the unwanted hydroxide |
| ion | | ion transfer does not deplete the strontium |
| | | ions. |
| | | Also, it does not disturb the ionic balance in |
| | | the process medium since there is already the |
| | | charge balancing ion transport mechanism to |
| | | move out equivalent chloride ions. |
| | | State of the art sulphate/sulphite ion transport |
| | | technology is inefficient; hence, other systems |
| | | cannot use it viably, but methods disclosed |
| | | herein can successfully overcome the impact |
| | | of the inefficiency. |
| Over- | The | Along with the desired movement of chloride |
| coming | inefficiency | ions, some unwanted strontium ions may also |
| the | of Chloride | move from process medium to capture |
| Practical | ion | medium. These strontium ions combine with |
| inefficiency | transfer | the sulphate ions in the capture medium to |
| of the | | form a precipitate of strontium |
| charge- | | sulphate/sulphite salts. So, these strontium |
| balancing | | ions do not remain dissolved in the capture |
| ion | | medium and does not interfere with the SO₂ |
| transport | | capture process into process medium. In other |
| mechanism | | state of the art systems, the unwanted |
| | | strontium ions thwart the ability of SO₂ to |
| | | dissolve in a water solution by neutralising the |
| | | alkalinity of the capture solution. |
| Optional | Improve | Highly selective/highly efficient ion |
| improve- | efficiency | transport mechanisms may be used as and |
| ment | | when they become available in future; the |
| features | | system can work with the existing inefficient |
| | | ion transport mechanisms. |
| Optional | Ion | Unclogging methods such as ultrasonic |
| features | Transport | vibrators or polarity reversals may prevent the |
| | Anti | precipitates from scaling or clogging the ion |
| | Clogging | transport mechanism. |

TABLE 3 provides a brief summary of selected features and non-limiting examples of methods and apparatus disclosed herein or embodiments relating to CO₂ capture from air/smoke/pre-concentrated CO₂ to produce H₂CO₃, and to liberate pure CO₂ gas.

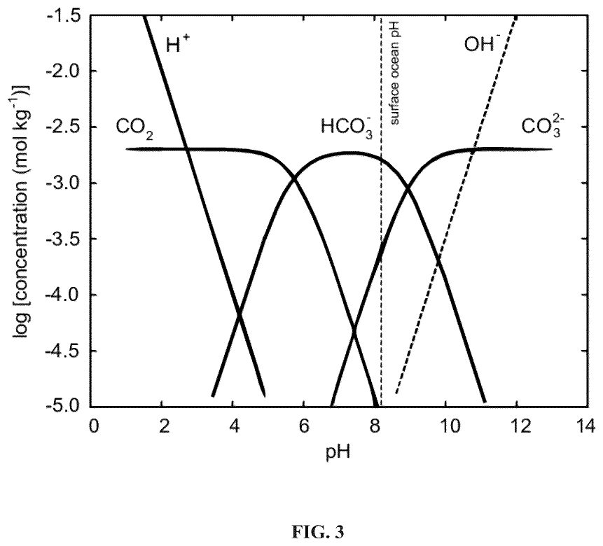

TABLE 3
Brief summary of selected features and non-limiting examples
of methods and apparatus disclosed herein or embodiments
relating to CO₂ capture from air/smoke/pre-concentrated
CO₂ to produce H₂CO₃, and to liberate pure CO₂ gas.

| | Non- | |
|---|---|---|
| | limiting | |
| Feature | Example | Description |
| Target | CO₂ | It may be from the CO₂ in the air, industrial |
| substance | | smoke, and/or pre-concentrated CO₂. |
| Capture | Alkaline | Minimum pH of the solution is inversely |
| medium | solution | proportional to the concentration of the |
| | with | source of CO₂ used. |
| | pH ≥9.5 | E.g., pH may be maintained at least 13.5 if |
| | | CO₂ from the air is being directly captured, |
| | | and maintained at least 9.5 if pre- |
| | | concentrated CO₂ is being captured. |
| | | If the pH is lower than the minimum pH, |
| | | then alkali may be added to increase the pH |
| | | above the minimum pH. |
| Capture | Water | When the pH of the water source is |
| medium | used for | adjusted to pH ≥9.5, most of the dissolved |
| (when | capture | CO₂ is converted to carbonate ions, which |
| capture | medium | adds to the carbonate ions being produced |
| medium | already | by capturing CO₂ from the source of CO₂ |
| already | has some | used in this process. Also, undesirable |
| contains | dissolved | insoluble hydroxides are removed due to |
| dissolved | CO₂ | precipitations. |
| CO₂) | | Example: Adding NaOH to Seawater |
| | | produces 0.0025 Molar carbonate ion |
| | | solution; this produces 0.0025 molars |
| | | carbonic acid with a pH of 4.49. However, |
| | | at this low pH, carbonic acid is not stable |
| | | and mostly dissociates to H₂O and CO₂. |
| | | Hence, the carbonate ion concentration in |
| | | the capture medium is higher than the |
| | | carbonic acid solubility in process |
| | | medium. |
| Target | Carbonate | For the carbonate ion transport |
| ion | ions | mechanism, pH of the capture medium |
| | | should be more than 9.5 so that the |
| | | dissolution of CO₂ produces more |
| | | carbonate ions than bicarbonate ions. At |
| | | pH lower than 9.5, more bicarbonate ions |
| | | are produced instead of carbonate ions, |
| | | which reduces efficiency. Hence, if the pH |
| | | is below 9.5, then some alkali may be |
| | | added to increase the pH above 9.5 |
| Process | Pure Water | This may be either pure water or acidic |
| medium | or neutral/ | water with pH <7.0. If pH >7.0, some acid |
| | acidic water | or acidic salt may be added to reduce the |
| | with a | pH below 7.0. |
| | pH <7.0 | |
| Ion | Carbonate | This is along the concentration gradient |
| transport | Ion from | (high concentration in Capture medium, |
| mechanism | Capture | low concentration in process medium). |
| (for target | medium to | The electrical potential may be used to |
| ion)— | process | make the ions move, but a lower electrical |
| Primary | medium | potential may be used since it is in the |
| Ion | | direction of the concentration gradient. |
| Transport | | More electrical charge is required in other |
| Mechanism | | systems because the movement is against |
| | | the gradient. |
| Charge | H⁺ ion | This is against the concentration gradient |
| Balancing | from | (high concentration in process medium, |
| Ion | Capture | low concentration in Capture medium) |
| Transport | medium | because the pH of process medium is lower |
| Mechanism | to process | than the pH of Capture medium. Electricity |
| | medium | may be used to make the ions move. Still, |
| | | less electrical energy may be used since it |
| | | is only used to replenish the H⁺ ions in the |
| | | process medium and not to reduce its pH |
| | | value. More electrical charge is required in |
| | | other systems because the movement |
| | | causes a drop in pH value (the solution |
| | | becomes more acidic). |
| Charge | H⁺ Ion | This counterbalancing ion movement |
| Balancing | | maintains electrical balance and reduces |
| Ion | | electricity consumption. In other state of |
| | | the art systems, the flow of electrons |
| | | between the anode and cathode is used to |
| | | balance the charge, so these other systems |
| | | use more electricity. |
| | | Also, this ensures that every time one |
| | | carbonate ion moves to the process |
| | | medium, two H⁺ ions also move to the |
| | | process medium to combine with this |
| | | carbonate ion to form carbonic acid (2H⁺ + |
| | | CO₃²⁻═H₂CO₃) in the process medium. |
| | | As the concentration of carbonic acid |
| | | increases beyond the solubility limit, the |
| | | excess carbonic acid dissociates into water |
| | | and CO₂ (H₂CO₃═H₂O + CO₂). This CO₂ |
| | | bubbles out of process medium as a pure |
| | | CO₂ gas stream |
| | | By moving one carbonate ion CO3²⁻ from |
| | | capture medium to process medium along |
| | | concentration gradient and two H⁺ ions |
| | | from capture medium to process medium |
| | | against concentration gradient, H₂CO₃ |
| | | may be formed in the process medium. |
| | | When the process medium is kept at pH |
| | | slightly <7.0, the H₂CO₃ may dissociate |
| | | and form other carbonic ion species, as per |
| | | FIG. 3. Some, though may not be all, may |
| | | also be released as CO₂ gas when pH is |
| | | only slightly below pH 7.0. Rest of the |
| | | CO3²⁻ may change to HCO₃⁻ to form |
| | | bicarbonate precipitates such as sodium |
| | | bicarbonate using this system along with |
| | | release of CO₂ gas. |
| | | If the two H⁺ ions are not moved, then the |
| | | process medium may become alkaline. |
| | | However, since two H⁺ ions are moved for |
| | | every CO3²⁻ ion, the process medium may |
| | | remain acidic, with pH <7.0. Thus, when |
| | | pH of process medium is maintained below |
| | | pH 4.5, majority of the H₂CO₃ dissociation |
| | | may cause CO₂ to bubble out of the process |
| | | medium. |
| | | In the embodiments disclosed herein, |
| | | movement of the charge balancing ion H⁺ |
| | | is against concentration gradient. As such, |
| | | electricity may be applied to move the |
| | | ions. Either one or both of production of |
| | | pure CO₂ by operating at pH under 4.5, or |
| | | production of bicarbonate by operating at |
| | | pH around by slightly below pH7 may be |
| | | viable commercially. |
| Compound/ | CO₂ | This is a high-purity CO₂ gas stream that |
| Output | Gas | may be commercially exploited. |
| Concen- | The | The Capture medium is alkaline |
| tration | concentration | The process medium is acidic |
| Gradient | of H⁺ in | So, H⁺ ions may always more concentrated |
| of | process | in process medium than Capture medium. |
| Counter- | medium > | Note: The H+ ions move against the |
| balancing | Concentration | concentration gradient, from low |
| Ion | of H⁺ in | concentration in Capture medium to High |
| | Capture | Concentration in process medium |
| | medium | |
| Concen- | The | The solubility of Carbonate ions in alkaline |
| tration | Concentration | water (Capture medium) is high |
| Gradient | of Carbonate | The solubility of Carbonic Acid in acidic |
| of Target | Ions in | water (process medium) is low |
| Ions | Capture | So, Carbonate ions are always more |
| | medium > | concentrated in Capture medium than in |
| | Concentration | process medium. |
| | in process | |
| | medium | |
| Over- | No | Along with the desired movement of |
| coming | significant | Carbonate ions, some unwanted hydroxide |
| the | negative | ions (OH⁻) may also move from capture |
| Practical | impact of | medium to process medium. These |
| Inefficiency | the | undesired hydroxide ions may combine |
| of the | inefficiency | with the H⁺ ions already present in the |
| primary ion | of | process medium to form H₂O (water). |
| transfer | Carbonate | This removal of H⁺ ions does not impact |
| mechanism | Ion | the balance between H⁺ ions and other |
| | Transfer | negative ions in the process medium since |
| | | there is another counterbalancing ion |
| | | transport mechanism to move H+ from |
| | | Capture medium to process medium. |
| | | State of the art carbonate ion transport |
| | | technology is not very efficient; hence, |
| | | other systems cannot use it viably, but |
| | | methods disclosed herein can successfully |
| | | overcome the impact of the inefficiency. |
| Over- | No | Along with the desired movement of H+ |
| coming | significant | ions, some unwanted other positive ions |
| the | negative | may also move from Capture medium to |
| Practical | impact | process medium. These positive ions may |
| inefficiency | of the | combine with the negative ions in the |
| of the | inefficiency | process medium to form highly soluble |
| charge- | of H+ ion | ionic salts. So, these don't cause any |
| balancing | transfer | significant adverse impacts. |
| ion | | |
| transport | | |
| mechanism | | |
| Optional | Improve | Highly selective/highly efficient ion |
| improvement | efficiency | transport mechanisms may be used as and |
| features | | when they become available in future; the |
| | | system can work with the existing |
| | | inefficient ion transport mechanisms. |
| Optional | Ion | Unclogging methods such as ultrasonic |
| features | Transport | vibrators or polarity reversals may prevent |
| | Unclogging | the CO₂ gas bubbles or some scale deposits |
| | | from clogging the ion transport |
| | | mechanism. |

TABLE 4: Brief summary of selected features and non-limiting examples of methods and apparatus disclosed herein or embodiments relating to capture of SO₂ to produce H₂SO₄/H₂SO₃.

TABLE 4
Brief summary of selected features and non-limiting examples
of methods and apparatus disclosed herein or embodiments
relating to capture of SO₂ to produce H₂SO₄/H₂SO₃.

| Feature | Example | Description |
|---|---|---|
| Target | SO₂ | It may be SO₂ from air, industrial smoke, |
| substance | | or pre-concentrated SO₂. |
| Capture | Alkaline | Minimum pH of the solution may be at |
| medium | solution | least 9.5, so there is excess unreacted |
| | with | alkali to capture more SO₂ after the |
| | pH ≥9.5 | captured SO₂ has already reacted with |
| | | some of the alkali present in the capture |
| | | medium. |
| | | If the pH is lower than the minimum pH, |
| | | alkali (sodium hydroxide) may be added to |
| | | increase the pH above the minimum pH. |
| Capture | Water | When the pH of the water is adjusted to pH |
| medium | used for | ≥9.5, this neutralises all the acidic salts to |
| (when | the | form aqueous ionic salts (sulphates or |
| capture | capture | sulphites) and removes undesirable |
| medium | medium | insoluble hydroxides. |
| already | already | Example—Seawater produces 0.028 molar |
| contains | has | sulphate ion solution. This produces 0.28 |
| aqueous | aqueous | molar H₂SO₄ solution in the process |
| SO₂ | SO₂ ions | medium, which has a pH of pH1.55. This |
| ions) | | may be further concentrated by |
| | | atmospheric or vacuum distillation |
| Target | Sulphate/ | pH of the capture medium should be ≥9.5 |
| ion | Sulphite | so that the dissolution of SO₂ produces |
| | Ions | sulphate/sulphite ions in an aqueous |
| | | solution at a high capture rate. |
| | | If pH is below 9.5, alkali (sodium |
| | | hydroxide) may be added to increase pH |
| | | to ≥9.5 |
| Process | Pure Water | This may be either Pure Water or acidic |
| medium | or neutral/ | water with pH <7.0. If pH >7.0, some acid |
| | acidic water | or acidic salt may be added to reduce the |
| | with a | pH below 7.0. |
| | pH <7.0 | |
| Ion | Sulphate/ | This is along the concentration gradient |
| transport | Sulphite | (high concentration in Capture medium, |
| mechanism | Ion from | low concentration in process medium). |
| (for target | Capture | The electrical potential may be used to |
| ion)— | medium | make the ions move, but a lower electrical |
| primary ion | to process | potential may be used since it is in the |
| transfer | medium | direction of the concentration gradient. |
| mechanism | | More electrical charge is required in other |
| | | state of the art systems because the |
| | | movement is against the gradient. |
| Ion | H⁺ ion | This is against the concentration gradient |
| transport | from | (high concentration in process medium, |
| mechanism | Capture | low concentration in Capture medium) |
| (for charge | medium to | because the pH of process medium is |
| balancing | process | lower than the pH of Capture medium. |
| ion) | medium | Electricity is used to make the ions move. |
| | | Still, less electrical energy may be used |
| | | since it is only used to replenish the H⁺ |
| | | ions in the process medium and not to |
| | | reduce its pH value. More electrical |
| | | charge is required in other systems |
| | | because the movement causes a drop in pH |
| | | value (the solution becomes more acidic). |
| Charge | H⁺ Ion | This counterbalancing ion movement |
| Balancing | | maintains electrical balance and reduces |
| Ion | | electricity consumption. In other state of |
| | | the art systems, the flow of electrons |
| | | between the anode and cathode is used to |
| | | balance the charge, so other systems use |
| | | more electricity. |
| | | Also, every time one sulphate ion moves |
| | | to the process medium, two H⁺ ions also |
| | | move to the process medium to combine |
| | | with this sulphate ion to form sulphuric |
| | | acid (2H⁺ + SO₄²⁻═H₂SO₄) in the process |
| | | medium. This is the end product—H₂SO₄. |
| | | Also, every time one sulphite ion moves to |
| | | the process medium, two H⁺ ions also |
| | | move to the process medium to combine |
| | | with this sulphite ion to form sulphurous |
| | | acid (H⁺ + SO₃²⁻═H₂SO₃) in the process |
| | | medium. This is the end product—H₂SO₃. |
| Com- | H₂SO₄/ | This is a low pH, high molarity H₂SO₄/ |
| pound/ | H₂SO₃ | H₂SO₃ acid solution that may be |
| Output | Solution | commercially exploited. |
| Concen- | The | The Capture medium is alkaline |
| tration | concentration | The process medium is acidic |
| Gradient | of H+ | So, H+ ions may be more concentrated in |
| of charge | in process | process medium than Capture medium. |
| balancing | medium > | Note: The H+ ions move against the |
| | Concentration | concentration gradient, from low |
| | of H+ in | concentration in Capture medium to High |
| | Capture | Concentration in process medium |
| Ion | medium | |
| Concen- | The | The solubility of Sulphate/Sulphite ions |
| tration | Concentration | in alkaline water (Capture medium) is |
| Gradient | of | high. E.g., the Solubility of Na₂SO₄ is 2.64 |
| of | Sulphate/ | Molar. |
| Target | Sulphite | The solubility of sulphuric Acid in acidic |
| Ions | Ions in | water (process medium) is low. E.g., the |
| | Capture | pH of 1 molar H₂SO₄ is pH0.0 while one |
| | medium > | molar H₂SO₃ is pH 0.97, and this one |
| | Concentration | molar concentration in process medium is |
| | in | much lower than Na₂SO₄ concentration in |
| | process | capture medium. |
| | medium | So, Sulphate/Sulphite ions may be more |
| | | concentrated in capture medium than |
| | | process medium. |
| Over- | No | Along with the desired movement of |
| coming | significant | Sulphate/Sulphite ions, some unwanted |
| the | negative | hydroxide ions (OH—) may also move from |
| Practical | impact of | capture medium to process medium. These |
| Inefficiency | the | undesired hydroxide ions may combine |
| of the | inefficiency | with the H+ ions already present in the |
| primary | of | process medium to form H₂O (water). |
| ion | Sulphate/ | This removal of H⁺ ions may not impact |
| transfer | Sulphite | the balance between H⁺ ions and other |
| mechanism | Ion | negative ions in the process medium since |
| | Transfer | there is another counterbalancing ion |
| | | transport mechanism to move H⁺ from |
| | | capture medium to process medium. |
| | | State of the art sulphate/sulphite ion |
| | | transport technology is not very efficient; |
| | | hence, other systems cannot use it viably, |
| | | but this system can successfully overcome |
| | | the impact of the inefficiency. |
| Over- | No | Along with the desired movement of H⁺ |
| coming | significant | ions, some unwanted other positive ions |
| the | negative | may also move from capture medium to |
| Practical | impact of | process medium. These positive ions may |
| inefficiency | the | combine with the negative ions in the |
| of the | inefficiency | process medium to form highly soluble |
| charge- | of H+ ion | ionic salts. So, these do not cause any |
| balancing | transfer | significant adverse impacts. |
| ion | | |
| transport | | |
| mechanism | | |
| Optional | Improve | Highly selective/highly efficient ion |
| features | efficiency | transport mechanisms may be used as and |
| | | when they become available in future; the |
| | | system can work with the existing |
| | | inefficient ion transport mechanisms. |
| Optional | Ion | Unclogging methods such as ultrasonic |
| features | Transport | vibrators or polarity reversals may prevent |
| | Unclogging | the gas bubbles or some scale deposits |
| | | from clogging the ion transport |
| | | mechanism. |

### Example 9: Direct Capture CO₂ from Air—Cyclic Process

### A) Working

In various embodiments, capture medium is alkalised aqueous solution and process medium is Zinc Chloride solution, which is an acidic solution. When the capture medium is contacted with air by circulating the capture medium through an infill (e.g., in a cooling tower), the CO₂ from air dissolves in capture medium to form target anions, i.e., the bicarbonate and carbonate ions. These target anions flow from capture medium to the process medium via the ion transport mechanism to react with the cations in the process medium to form the precipitate of target anions.

The sacrificial anion i.e., chlorine ions from process medium flow from the process medium to the capture medium via the ion transport mechanism to continually increase concentration of the sacrificial anions in the capture medium until concentration of the sacrificial anions equalises between the process medium and the capture medium. The precipitate is extracted and used for desired purposes or optionally, electrolyze the capture medium i.e., the chloride salt solution thus formed. This leads to generation of hydroxide alkali and hydrochloric acid. Hydroxide alkali may be used to maintain alkalinity of the capture medium and hydrochloric acid may be used to regenerate the process medium and to release a stream of target gas i.e., CO₂ gas.

An example is sodium chloride cycle, whereby ion exchange membrane cell is used with capture medium being sodium hydroxide and process medium being hydrochloric acid.

Same setup can be used for other metal chlorides whose chlorides, hydroxides, carbonates, and bicarbonates are soluble in water. An example is potassium chloride, whereby capture medium may be potassium hydroxide, whereas process medium may be hydrochloric acid (HCl), whereby potassium chloride, potassium hydroxide, potassium carbonate and potassium bicarbonate are all soluble in water.

### B) Chemical Reactions

Sodium Chloride (aq)→Electrolysis→Sodium Hydroxide+Hydrochloric Acid
Water+CO₂ (gas from air)→Carbonate and Bicarbonate ions
Sodium Hydroxide+Carbonate/Bicarbonate ions→Sodium Carbonate (aq) and Sodium Bicarbonate (aq)
Sodium Carbonate (aq)+Zinc Chloride→Zinc Carbonate (precipitate)+Sodium Chloride (aq)
Sodium Bicarbonate (aq)+Zinc Chloride→Zinc Carbonate (precipitate)+Sodium Chloride (aq)
Zinc Carbonate (precipitate)+Hydrochloric Acid→Zinc Chloride (aq)+CO₂ (gas)

### C) Advantage

With a calcium carbonate based process, a challenge is that the NaOH solution is limited to 1 mol/L since use of the calcium cycle at higher NaOH concentrations results in precipitation of unwanted calcium hydroxide. However, using a method disclosed herein, a higher concentration of NaOH can be used in capture medium because only carbonate/bicarbonate ions flow via the anion transport mechanism from capture medium to process medium where the precipitate is formed and the sacrificial anions flow back to capture medium via the anion transport mechanism to form aqueous solution in the capture medium.

### D) Process Steps—pH Range Around 7

According to an embodiment, aqueous pH neutral NaCl solution is the process medium, prepared using natural water, whereby electrolysis is carried out to form sodium hydroxide (capture medium) and hydrochloric acid (process medium). Although there may be some calcium and magnesium impurities, these do not matter. As distilled or desalinated or freshwater is not needed, and pure NaCl is not needed, this reduces cost of starting raw materials significantly. For example, sodium chloride or HCl do not have to be purchased since they may be obtained by electrolysis of aqueous neutral pH NaCl solution. Furthermore, sodium chloride brine may be formed using methods disclosed herein as chloride ions move from process medium to capture medium, which may be further electrolyzed to prepare more sodium hydroxide and hydrochloric acid. The sodium hydroxide may be used to replenish capture medium, whereas the hydrochloric acid may be used to replenish process medium, or be reacted with zinc carbonate precipitate removed from the process medium to form zinc chloride so as to replenish process medium and to liberate CO₂ gas.

The capture medium of sodium hydroxide is exposed to CO₂ from the air which leads to the carbonation of water resulting in the formation of carbonate and bicarbonate ions in the capture medium. Depending on how long it has been exposed to air, pH reading of distilled water (the electrolysis step makes the capture media alkaline and process media acidic, then the alkaline capture media is exposed to CO₂ or SO₂ to capture the acid anhydride) drops from 7 to a range between 5.5 and 6.9. If it has been left open to the air, the pH can even fall just below 5.5; while the pH of water containing cations increases to a range between pH 8 and pH 9 due to the formation of carbonates and bicarbonates.

The anion transport mechanism may be used to allow flow of the dissolved target anions of CO₂ gas (carbonates and bicarbonates) from capture medium to process medium, so the carbonate precipitate is obtained in the process medium, while the concentration of chloride salts increases in the capture medium. This step involves natural diffusion since zinc chloride brine in the process medium has less carbonate and bicarbonate anions in the solution, hence having a lower concentration than the concentration of carbonate and bicarbonate anions in the process medium. Also, concentration of chloride ions in the zinc chloride brine is higher than in the process medium.

This step continues since this concentration gradient is stable.

Solubility of zinc carbonate is less than the solubility of calcium and magnesium carbonate and much less than the solubility of sodium carbonate. So, the carbonate ions that cross over from capture medium to process medium keep precipitating while the capture medium keeps gaining more CO₂ from the air. So, the gradient is stable and keeps driving the diffusion across the membrane.

The capture medium, zinc chloride solution, is a brine, while process medium is from natural sources and hence has a much lower chlorine ion concentration than zinc chloride brine.

When chlorine ions crossover to process medium, charge balance is maintained by the equivalent charge of carbonate/bicarbonate ions crossing over to zinc chloride brine and getting precipitated. So, zinc and chlorine ion ratio is maintained, but the overall concentration of zinc chloride reduces, although it is still significantly higher than the process medium.

The capture medium may then be electrolysed, to generate hydrochloric acid and hydroxide alkali. The hydroxide alkali then maintains the pH of capture medium so it can take up more CO₂ from the air, while the hydrochloric acid reacts with zinc carbonate precipitate to regenerate zinc chloride which is used to top-up the zinc chloride brine for the loss of zinc and chlorine ions.

Using a method disclosed herein, even if the capture medium has calcium or magnesium impurities, the carbonate cycle is not interfered with by these impurities, since the solubility of zinc carbonate is lower than the solubility of calcium carbonate/bicarbonate and magnesium carbonate/bicarbonate.

### E) Process Steps—High pH Range

Step 1: In the starting step of this embodiment, the capture medium is less than 50% NaOH (pH=13-14) because at or above this pH range, sodium carbonate may not be soluble.

Step 2: This solution, i.e. capture medium, is exposed to air: 2 NaOH (s)+CO₂ (g)→Na₂CO₃ (aq)+H₂O (l) [pH drops from above 13 to under 10].

Step 3: When pH drops to below 10, all NaOH has been reacted and Na₂CO₃ (aq) is formed.

Step 4: Thereafter, zinc carbonate precipitates in process medium: ZnCl₂ (aq)+Na₂CO₃ (aq)→ZnCO₃ (s)+2NaCl (aq).

Step 5: Consequently, pH of capture medium drops to around 7 and the capture medium becomes a concentrated NaCl solution.

At this juncture, the zinc carbonate precipitate may be extracted for commercial purposes. Optionally, the process may be continued to liberate CO₂ gas.

Step 6: Thereafter, NaCl water is electrolysed using membrane: NaCl (aq)+H₂O NaOH (aq)+HCl (aq).

Step 7: The NaOH is re-used in Step 2 to capture more CO₂ from air.

Step 8: The HCl is used to liberate CO₂ from ZnCO₃: 2HCl (aq)+ZnCO₃ (s)→ZnCl₂ (aq)+H₂O (l)+CO₂ (g).

### F) Energy Used

The Chlor-alkali membrane process consumes 2.10-2.15 kWh/kg NaOH of electrical energy and 0.128-0.196 kWh/kg NaOH of thermal energy i.e., total 2.30-2.35 KWh/kg of NaOH. If the cost of 1 KWh of electricity is on average 0.15US$, the total energy cost of NaOH is US$0.27 per kg to 0.38 per kg of NaOH. Since 1 kg of NaOH produces 1 kg of CO₂, so cost is US$0.27 to 0.38 per kg of CO₂ i.e., US$270 to US$380 per ton of CO₂.

### Example 10: Direct Capture CO₂ from Air—Single-Pass Process

### A) Economics

Zinc carbonate is more valuable in the industrial market than zinc chloride. E.g., the price of zinc chloride per ton is US$2848 per ton, while the cost of zinc carbonate is US$3407 per ton. E.g., the price of zinc chloride is INR 140+gst per kg, while the cost of zinc carbonate is INR 220+gst per kg.

### B) Process Working

Zinc chloride solution is used as process medium, and hence when carbonate or bicarbonate ions are transported by the anion transport mechanism, zinc carbonate precipitates in the process chamber. This zinc carbonate may be extracted and commercialised. Capture chamber and process chamber may be part of canister that may be disposed into a water chamber, e.g. cooling tower.

### C) Advantages

Simple arrangement: e.g., consider a canister with a selectively permeable anion exchange membrane incorporated into the canister. The canister has zinc chloride. The chlorine ions may flow out, thus preventing scaling in the capture medium, while the carbonate precipitates in the process medium. The process may stop when the chloride ion concentration in the canister is the same as the chloride ion concentration in the capture medium. The carbonate precipitate may be extracted from the canister, cleaned, and commercialized. The canister may be filled up with zinc chloride solution, and the single-pass cycle may be repeated.

Net positive value addition: methods disclosed herein is able to generate a positive value for the carbon capture process instead of most other carbon capture processes that have a net negative value addition for the carbon capture process.

### Example 11: Direct Capture CO₂ from Air—Soluble Carbonate Process Medium

Working: Capture medium is treated/softened to remove calcium and magnesium ions, or the carbonates are allowed to precipitate off leaving behind soft water. The process medium uses a soluble carbonate salt. The electrical energy is applied across the membrane to convert soluble carbonate into CO₂ gas and hydroxide. Hydroxide is used to capture more CO₂.

Advantages: Simple setup, uses only electrical energy as the input and produced pure stream of CO₂ gas.

### Example 12: Direct Capture of SO₂ from Air

### A) Design

Capture medium is either pure water or alkaline water to dissolve target gas (SO₂) in water to form target anion (sulphate) which is highly soluble in the capture medium, such that the target anion (sulphate) concentration in the capture medium is more than the process medium. [0263]process medium is a highly concentrated solution of strontium chloride such that the sacrificial anion (chlorine) concentration in process medium is more than the capture medium.

Ion transport mechanism may be designed to allow transport of target anion (sulphate) from capture medium to process medium, and to allow transport of sacrificial anion (chlorine) from process medium to capture medium.

The extraction mechanism may be designed to remove the target anion precipitate (strontium sulphate) from the process medium.

Top-up and maintenance mechanism may be designed to add strontium chloride to the process medium as and when required and to remove the chloride salt solution from the capture medium.

### B) Working

As SO₂ is able to dissolve in capture medium to form sulphate ion in high concentration, the sulphate ion may flow via the ion transport mechanism to the process medium, where the sulphate ion may form precipitate with strontium cation. The process medium may have high concentration of chloride anion due to high solubility of strontium chloride, so the chlorine anion may flow via the ion transport mechanism to the capture medium. Strontium sulphate precipitate may be extracted and commercialised, and strontium chloride may be topped up in the process medium.

### Example 13: Direct Capture CO₂ from Water Bodies

### A) Working

CO₂ may already be dissolved in water bodies to form bicarbonate and carbonate ions. When zinc chloride is added, zinc carbonate may be precipitated, and chlorine ions may form soluble aqueous salts of cations present in water. The chloride salt solution may be electrolyzed to form hydroxide alkali and hydrochloric acid. Hydroxide alkali may be used to maintain the alkalinity of water bodies for increased CO₂ absorption from the atmosphere, and hydrochloric acid may be used to regenerate zinc chloride and release CO₂.

TABLE 5 provides a summary of major ion composition of seawater (mg/L) according to an embodiment.

TABLE 5
Major ion composition of seawater
(mg/L) according to an embodiment

| | | | Arabian | The Red |
|---|---|---|---|---|
| | Typical | Eastern | Gulf at | Sea at |
| | Seawater | Mediterranean | Kuwait | Jeddah |
| Sodium (Na⁺) | 10.556 | 11.800 | 15.850 | 14.255 |
| Magnesium (Mg²⁺) | 1.262 | 1.403 | 1.765 | 742 |
| Calcium (Ca²⁺) | 400 | 423 | 500 | 225 |
| Potassium (K⁺) | 380 | 463 | 460 | 210 |
| Strontium (Sr²⁺) | 13 | — | — | — |
| Chloride (Cl⁻) | 18.980 | 21.200 | 23.000 | 22.219 |
| Sulfate (SO₄²⁻) | 2.649 | 2.950 | 3.200 | 3.078 |
| Bicarbonate(HCO₃⁻) | 140 | — | 142 | 146 |
| Bromide (Br⁻) | 65 | 155 | 80 | 72 |
| Borate (BO₃³⁻) | 26 | 72 | — | — |
| Fluoride (F⁻) | 1 | — | — | — |
| Silicate (SiO₃²⁻) | 1 | — | 1,5 | — |
| Iodide (I⁻) | <1 | 2 | — | — |
| Others | — | — | — | — |
| Total dissolved | 34.483 | 38.600 | 45.000 | 41.000 |
| solids (TDS) | | | | |

Note:
The dot (.) separates thousands; the comma (,) separates decimals.

### B) Method Steps and Advantage

Step 1: The zinc salts of all other anions in seawater are soluble, only hydroxides and carbonate and bicarbonates of zinc are almost non-soluble. Also, the solubility of zinc carbonate is less than the solubility of carbonates and bicarbonates of calcium and magnesium, while all other carbonates and bicarbonates of cations are present in seawater are soluble. Hence, a pure precipitate may be produced in the process medium and target anions may be depleted from seawater, and sacrificial ions may be added to seawater.

Step 2: When the capture medium i.e., seawater deprived of carbonates and bicarbonates is electrolysed before being re-exposed to target gases, hydroxides of magnesium and calcium may precipitate out. These precipitates are economically valuable raw materials that can be recovered before being discharged back into a water body. Moreover, zinc hydroxide is also non-soluble in water, so any small amount of zinc carbonate that is present in the capture medium may be precipitated out in this stage. This zinc can be separated from combined precipitate (zinc and calcium and magnesium) by a) chromate treatment, since the chromates of calcium and magnesium are soluble in water, but the chromate of zinc is non-soluble in water, and/or b) fluoride treatment, since the fluorides of calcium and magnesium are non-soluble in water, but the fluoride of zinc may be soluble in water.

Step 3: After the calcium and magnesium have been largely removed, this water is now “softened” water, and can be discharged back into the water body, then the remaining cations (sodium, potassium, and strontium) have very high solubility of hydroxides, chlorides, carbonates, and bicarbonates thereby increasing the capture rate of CO₂ when this capture medium i.e., seawater from which dissolved target anions have been removed, is allowed to be exposed to air.

Step 4: If this water is kept in a bounded area/pool where additional calcium and magnesium cannot dissolve in the water, the CO₂ capture may occur without further precipitation of calcium and magnesium, while pure zinc carbonate is precipitated, which can be commercialised.

Step 5: If the water is allowed to go back to a natural water body, it can pick up more calcium and magnesium from rocks, and the inlet may still contain some small amounts of carbonates of calcium and magnesium dissolved in water, as some calcium and magnesium may come out from the rocks in the seabed. These are handled as per Steps 1 and 2 above, and the cycle may be repeated.

### C) Chemical Reactions

Water+CO₂ (gas from air)→Carbonate and Bicarbonate ions
Cation Carbonate (aq)+Zinc Chloride→Zinc Carbonate (precipitate)+Cation Chloride (aq)
Cation Bicarbonate (aq)+Zinc Chloride→Zinc Carbonate (precipitate)+Cation Chloride (aq)

The process may be terminated and the zinc carbonate may be extracted to be commercialised or the process may continue as shown below to recover CO₂ gas.
Cation Chloride (aq)→Electrolysis→Cation Hydroxide (aq) and Magnesium/Calcium/Zinc Hydroxide (precipitates)+Hydrochloric Acid
Cation Hydroxide(aq)+Carbonate/Bicarbonate ions→Cation Carbonate (aq) and Cation Bicarbonate (aq)
Magnesium/Calcium/Zinc Hydroxide (precipitates)+Chromate→Magnesium/Calcium Chromate (aq) and Zinc Chromate (precipitate)
Magnesium/Calcium/Zinc Hydroxide (precipitates)+Fluoride→Magnesium/Calcium Fluoride (precipitate) and Zinc Fluoride (aq)
Zinc Carbonate (precipitate)+Hydrochloric Acid→Zinc Chloride (aq)+CO₂ (gas)

### D) Prevent Carbonate Scaling in Cooling Towers

Zinc carbonate is more valuable in the industrial market than zinc chloride. E.g., the price of zinc chloride per ton may be US$2848 per ton, while the cost of zinc carbonate may be US$3407 per ton. E.g., the price of zinc chloride is INR 140+gst per kg, while the cost of zinc carbonate is INR 220+gst per kg.

### E) Process Working

Zinc chloride solution is used as process medium, and the water in the cooling tower is used as capture medium. Hence, the target anions i.e., the carbonate or bicarbonate ions are transported by the anion transport mechanism, and zinc carbonate precipitates in the process chamber. This zinc carbonate may be extracted and commercialised.

### F) Advantages

Simple arrangement: e.g., consider a canister with an anion transport mechanism consisting of ion exchange resin or selectively permeable anion exchange membrane incorporated into the canister. The canister has zinc chloride as the process medium. The chlorine ions i.e., the sacrificial anions may flow out into the capture medium, while the target anions may flow into the process medium in the canister. Carbonate precipitation may occur in the process medium in the canister. The process may stop when the sacrificial anion, i.e., the chloride ion concentration in the process medium in the canister, is the same as the sacrificial anion, i.e., the chloride ion concentration in the capture medium which is water circulating in the cooling tower. The carbonate precipitate is extracted from the canister, cleaned, and commercialised. The zinc chloride solution is filled up in the canister, and the single-pass cycle may be repeated.

Net positive value addition: this process generates a positive value for the carbon capture process instead of most other carbon capture processes that have a net negative value for the carbon capture process.

### Example 14: Direct Capture of SO₂ from Water

### A) Design

Capture medium is aqueous solution containing target anion (sulphate) in medium to high concentration.

process medium is a highly concentrated solution of strontium chloride such that the sacrificial anion (chlorine) concentration in process medium is more than the capture medium.

Ion transport mechanism may be designed to allow transport of target anion (sulphate) from capture medium to process medium, and to allow transport of sacrificial anion (chlorine) from process medium to capture medium.

The extraction mechanism may be designed to remove the target anion precipitate (strontium sulphate) from the process medium.

Top-up and maintenance mechanism may be designed to add strontium chloride to the process medium as and when required and to remove the chloride salt solution from the capture medium.

### B) Working

Capture medium contains sulphate ion in high concentration, so the sulphate ion is able to flow via the ion transport mechanism to the process medium, where the sulphate ion forms a precipitate with strontium cation. The process medium may have high concentration of chloride anion due to high solubility of strontium chloride, so the chlorine anion may flow via the ion transport mechanism to the capture medium. Strontium sulphate precipitate may be extracted and commercialised, and strontium chloride may be topped up in the process medium.

### Example 15: Method to Prevent Carbonate Scaling in Cooling Towers

### A) Problem Statement

When there is carbonate in water such as from natural water bodies or from industrial sources, or when there is CO₂ gas in air, the water may have high carbonate content. Carbonate solubility may depend on cations in water. For example, if there are calcium and magnesium cations in water, the calcium carbonate may precipitate and cause scaling.

### B) Method to Prevent Carbonate Scaling

Zinc carbonate and strontium carbonate are nearly insoluble in water. Hence, Zinc or Strontium cations can be used in process medium to precipitate out the target anions i.e., carbonate anions. The sacrificial anions need to create highly soluble salts with zinc and/or strontium as well as with the cations in the capture medium which are typically sodium, magnesium, and calcium. Appropriate sacrificial anions can be selected e.g., chlorides of zinc and strontium are highly soluble, and these chlorides can also create highly soluble salts with sodium, magnesium, and calcium. Strontium chloride is cheaper or same price as strontium carbonate, zinc chloride is cheaper than zinc carbonate.

Hence, for process medium, sacrificial anion=chloride; cation=strontium or zinc; and for capture medium, target anion=carbonate or bicarbonate, and cation=sodium, magnesium, calcium etc.

This is technically as well as economically feasible; with ion transport mechanism based on target ion=carbonate or bicarbonate anion, and sacrificial ion=chloride anion.

### Example 16: Method to Prevent Sulphate Scaling in Cooling Towers

### A) Problem Statement

When there is sulphate in water such as from natural water bodies or from industrial sources, or when there is SO₂ gas in air, the water has high sulphate content. Sulphate solubility depends on cations in water. For example, sodium sulphate and zinc sulphate are soluble, but calcium sulphate is relatively less soluble so if there are calcium cations in water, the calcium sulphate can precipitate and cause scaling.

### B) Method to Prevent Sulphate Scaling

Strontium sulphate is nearly insoluble in water. Hence, strontium cations can be used in process medium to precipitate out the target anions i.e., sulphate anions. The sacrificial anions need to create highly soluble salts with strontium as well as with the cations in the capture medium which are typically sodium, magnesium, and calcium. From the solubility chart, the appropriate sacrificial anions can be selected e.g., chlorides of strontium are highly soluble, and these chlorides also create highly soluble salts with sodium, magnesium, and calcium. Strontium chloride is cheaper than Strontium sulphate.

Hence, for process medium, sacrificial anion=chloride; cation=strontium; for capture medium, target anion=sulphate, and cation=sodium, magnesium, calcium etc.

This is technically as well as economically feasible; with ion transport mechanism based on target ion=sulphate ion and sacrificial ion=chloride ion.

### Example 17: Prevent Carbonation and Sulphonation of CaCl₂)/Liquid Metal Chloride Desiccant Solutions

### A) Problem Statement

Liquids desiccant can be used to dry the air for various industrial applications including air cooling purposes. However, when chloride salts solutions are used as desiccants, carbonates and sulphates may precipitate out thus consuming the desiccant and causing scaling problems.

### B) Suggested Solution: Use Carbonate and Sulphate Ion Transport Technology

Typically, zinc carbonate is more valuable in the industrial market than zinc chloride, and strontium sulphate is more valuable in the industrial market than strontium chloride. E.g., the price of zinc chloride per ton may be US$2848 per ton, while the cost of zinc carbonate may be US$3407 per ton. E.g., the price of zinc chloride may be INR 140+gst per kg, while the cost of zinc carbonate may be INR 220+gst per kg. Eg., the price of strontium chloride may be INR 105-250 per kg depending on the purity, while the price of strontium sulphate may be INR 180-350 per kg depending on the purity, and the price of strontium carbonate may be INR 120-220 depending on purity—these are bulk industrial prices.

### C) Process Working

Zinc chloride or strontium chloride solution is used as process medium, and hence when carbonate or bicarbonate ions or sulphate ions flow via the ion transport mechanism, zinc carbonate or strontium sulphate may precipitate in the process chamber. The zinc carbonate or strontium sulphate may be extracted and commercialized, and replaced with zinc chloride solution.

### D) Advantages

Simple arrangement: e.g., consider a canister, i.e. the process medium, with ion exchange resin or selectively permeable anion exchange membrane incorporated into the canister. The canister has zinc chloride or strontium chloride. The chlorine ions is able to flow out of the canister preventing scaling in the capture medium, while the carbonate or sulphate may precipitate in the canister in the process medium. The process stops when the chloride ion concentration in the canister is the same as the chloride ion concentration in the capture medium. The carbonate or sulphate precipitate may be extracted from the canister, cleaned, and commercialised. The zinc chloride or strontium chloride solution may be filled up in the canister, and the single-pass cycle may be repeated.

Net positive value addition: this process generates a positive value for the carbon capture process instead of most other carbon capture processes that have a net negative value for the carbon capture process.

### Example 18: Remove Carbonates and Sulphates from Seawater

During the thermal desalination process, the carbonates and sulphates tend to precipitate out and cause scaling thus requiring frequent maintenance of the thermal desalination equipment. The proposed method can be used to remove the carbonates and sulphate and replace with the chlorine ions. The advantage is that the chloride solutions of the cations present in sea water are highly soluble versus low solubility of the carbonate and sulphate. Therefore, the thermal desalination process can concentrate the seawater to a higher degree before the chlorine salts reach saturation levels. Moreover, the chlorine salts are edible and can be used as common salt, while the strontium sulphate, strontium carbonate, and zinc carbonate produced by this proposed method are more valuable than the inputs—zinc chloride and strontium chloride, thus creating a net economic value addition.

### A) Explanation of how the Existing Direct Air Capture of CO₂ Processes Work

Typically highly alkaline solution of sodium hydroxide or calcium hydroxide is circulated through air-water infill media to enable carbon dioxide to be dissolved in water. In high pH levels (alkaline solution), the dissolved carbon dioxide exists as carbonate ions in alkaline solutions, hence carbonate salts of sodium and calcium may be generated.

Calcium carbonate is insoluble and may precipitate out of solution. Calcium carbonate may be heated to about 900 degree Celsius, to liberate CO₂ and calcium oxide. The calcium oxide may be dissolved in water to form calcium hydroxide, and the cycle may be repeated to capture more CO₂ from air.

Sodium carbonate is highly soluble in water, so it may precipitate out at higher concentrations. Sodium Carbonate is heated to about 1200 degree Celsius to liberate CO₂ and sodium oxide which may be reused to capture more CO₂ from the air.

### B) Disadvantages of State of the Art Processes

A high amount of water is evaporated away and wasted.

A high amount of impurities in the air like silica dust, iron dust, acidic gases like SO₂ and HCl, etc are also captured by the water. Oxygen also gets dissolved in water and reacts with iron particles to create rust which precipitates out. This leads to precipitates of hydroxide precipitates of iron and silica. So, the calcium and sodium oxides being regenerated in the existing processes become impure and may need treatment regularly to maintain purity levels.

Water also has some calcium and magnesium salt solutions, so their carbonates may also precipitate out.

Scaling of the salts occurs all over the machinery. This may require frequent maintenance or use of chemical dispersants.

The high temperatures of 900 degree Celsius and 1200 degree Celsius is extremely difficult to obtain purely by concentrated solar, and the thermodynamic heat pump process to produce these temperatures may be very inefficient due to the theoretical limits of Carnot's Theorem.

### C) Using Carbonate and Sulphate Ion Transport Cycle to Overcome the Disadvantages of State of the Art Methods

Zinc carbonate and strontium carbonate have lower solubility constant than carbonates of sodium, magnesium, and calcium. Further, the strontium sulphate may have lower solubility content than the sulphates of sodium, magnesium, calcium. Therefore, zinc carbonate and strontium carbonate tend to precipitate out of the solution before the carbonate precipitation of sodium, calcium, and magnesium, if zinc ion or strontium ion concentration is higher than the ions of sodium/magnesium/calcium in the water solution. This can be easily achieved by adding highly soluble solutions of zinc salts like zinc chloride or strontium salts like strontium chloride in process water. Likewise, strontium sulphate can be precipitated out.

Further, the zinc chloride or strontium chloride based process medium may be contained in the process chamber in the canister, with an ion transport mechanism (eg., selectively permeable anion exchange membrane) so the chloride anions can go out of the canister and sulphate and/or carbonate anions can enter the canister.

If the pH is maintained below 8, there are insufficient hydroxide ions but the high amount of carbonate ions and bicarbonate ions, thus the zinc Carbonate salt may precipitate within the canister process medium, before any carbonate scaling occurs in the rest of the water solution (capture medium), also due to pH below 8 in process medium the hydroxide scaling also would not occur in the process chamber. The chloride salts of calcium and magnesium and iron are soluble in water, so chloride scaling does not occur as well in capture medium. Likewise, strontium sulphate can be precipitated out to remove sulphate ions, by using strontium sulphate in the process medium and using a sulphate ion transport mechanism.

Zinc carbonate can be used for desired purposes or can be heated to produce Zinc oxide and CO₂ gas at temperatures below 400 degree Celsius, which can be achieved with concentrated solar, thus the process can work without any fossil fuels and any thermodynamic heat pumps. The zinc oxide can be further reused for desired purposes or cycled back to capture more CO₂ from the air.

Strontium carbonate and strontium sulphate may also similarly be commercialised or decomposed to regenerate Strontium Chloride.

### D) Practical Implementation

Discharge Cycle: Zinc or strontium salt canisters can be lowered in a lake or a water tank, or even the water tank of a cooling tower. The zinc or strontium inside the canister may turn into zinc carbonate, or strontium carbonate or strontium sulphate.

Recharge Cycle: The carbonate or sulphate precipitate in the canister can simply be extracted out and commercialized while zinc chloride or strontium chloride can be filled back in the canister.

### E) Advantages

This method can be safely used in existing natural or artificial water bodies.

No artificial circulation of air-water is needed. If air-water is circulated, e.g. in cooling tower systems, additional incremental fan power is not needed.

Tackles scaling problems in water tanks and cooling tower systems, thus it is beneficial to operators of cooling towers.

No additional water loss occurs, since the cooling tower or natural/artificial water bodies are already in contact with air; no additional air-water contact is needed.

Zinc carbonate is more expensive than zinc chloride so the precipitated carbonate can be commercialised and zinc chloride refilled in the canister.

Strontium carbonate and strontium sulphate are more expensive than strontium chloride so the precipitated can be commercialised while the strontium chloride can be refilled in the canister.

Thus the technology can help capture carbon dioxide and sulphur dioxide and their respective aqueous anions sustainably from air and water, at lower energy spends, lower water spends, using safe and in-situ available chemicals, with a net positive economic value addition.

### F) Experimental Evidence

### Using Tap Water

Step 1: Tap water was taken, and temperature and pH values were measured. 6 beakers were filled with this tap water, at 500 ml each. Temperature=room temperature. pH=slightly above 7, confirming that tap water is weakly alkaline.

Step 2: 5 salts were taken—sodium carbonate, sodium bicarbonate, magnesium carbonate, calcium carbonate, zinc chloride, and saturated solutions were prepared for each of them. Temperature and pH were measured after 1 minute. 1 beaker of only tap water was kept for later use. Temperature Change=+/−1 Degree change, confirming that hydrolysis has occurred. As for pH, pH rises above 7 for all carbonate and bicarbonate salt solutions; pH drops below 7 for zinc chloride solution, thus confirming the hydrolysis reactions have occurred. pH also rises for tap water solution confirming that CO₂ dissolves in tap water containing cations to form carbonate and bicarbonate ions.

Step 3: The mixtures were kept overnight to allow CO₂ from air to dissolve in water.

Step 4: Next day morning, temperature and pH in all 6 beakers were measured. Temperature=room temperature. As for pH, the pH for tap water rises above 7 confirming that CO₂ has dissolved in water; pH for zinc chloride solution also remains the same, providing confirmation CO₂ does not dissolve in zinc chloride solution.

Step 5: 1 to 2 teaspoonful of zinc chloride solution was added in all 4 carbonate and bicarbonate salts. Temperature and pH were measured after 1 minute. Temperature=21 degree Celsius+/−1 degree Celsius change. As for pH, the pH of all the carbonate and bicarbonate solutions dropped.

Step 6: Outcome—Zinc Carbonate precipitates were formed in all solutions.

### Using Carbonated Water

Step 1: Soda water was used, and temperature and pH values were measured. 6 beakers of 150 ml each were filled with soda water. Temperature was 21 degree Celsius i.e., room temperature. pH was below 6 confirming that pH of water with dissolved CO₂ is in a weak acidic range.

Step 2: 5 salts of sodium carbonate, sodium bicarbonate, magnesium carbonate, calcium carbonate, and zinc chloride were taken, and saturated solutions for each of them were prepared. 1 beaker of only soda water was kept. pH in all solutions was lower than the pH obtained using tap water, confirming that presence of CO₂ in water led to a drop in pH.

Step 3: The beakers were kept overnight to allow CO₂ in the air to form an equilibrium with these solutions. The pH was the same as the pH observed in tap water solutions which were kept overnight in exposure to air containing CO₂, thus confirming that ultimately same equilibrium is achieved between CO₂ in air and CO₂ dissolved in water irrespective of the initial amount of CO₂ gas dissolved in water used to begin the experiment.

Step 4: 1 to 2 teaspoonful of zinc chloride solution was added in all 4 carbonate and bicarbonate salt solutions. Temperature and pH were measured after 1 minute. pH observed were same as the pH observed when tap water was used for experiment, thus confirming that reactions depend on equilibrium state irrespective of starting/initial state.

Step 5: Outcome—Zinc Carbonate precipitates were formed since the solutions have dissolved CO₂.

### Using Distilled Water

Step 1: Distilled water was used, and temperature and pH value were measured. 6 beakers of 450 ml each were filled. pH was 7 but quickly dropped to below 6, thus confirming that CO₂ dissolves in pure water to form carbonic acid.

Step 2: 5 salts of sodium carbonate, sodium bicarbonate, magnesium carbonate, calcium carbonate, and zinc chloride were used. Saturated solutions for each of them were prepared. Temperature and pH were measured after 1 minute. 1 beaker that contains distilled water was kept. pH was same as the pH observed when using tap water or carbonated water, thus reconfirming those saturated solutions have a stable pH.

Step 3: The mixtures were kept overnight to allow CO₂ from air to mix with the solutions and form equilibrium. Next day morning, temperature and pH were measured in all 6 beakers. The pH of water was below 6 confirming pH of pure water dropped when exposed to air due to formation of carbonic acid. Specifically, due to absence of cations, carbonate and bicarbonate ions were not formed.

Step 4: 1 to 2 teaspoonful of zinc chloride solution was added in all 4 carbonate salts. Temperature and pH were measured after 1 minute. pH observed were the same as the pH observed when tap water was used for experiment, thus confirming that reactions depend on equilibrium state irrespective of starting/initial state.

Step 5: Outcome—Zinc carbonate precipitates were formed since the distilled water can capture CO₂ from the air and form equilibrium.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1.-50. (canceled)

51. A method for removing a target substance from a gas, the method comprising
providing a capture medium comprising an alkaline aqueous solution for dissolving the target substance comprised in the gas to form a target ion in the capture medium,
contacting the target substance comprised in the gas with the capture medium to form a target ion in the capture medium, and
transporting the target ion comprised in the capture medium to a process medium via an ion transport mechanism which is operable to have the target ion move from the capture medium to the process medium in the absence of an electrical potential, wherein the process medium comprises an aqueous solution comprising an ion having an electric charge opposite to that of the target ion, and which interacts with the target ion to form a compound in the process medium, wherein the ion transport mechanism is adapted to allow a flow of ions between the capture medium and the process medium to maintain charge balance.

52. The method according to claim 51, wherein either one or both the capture medium and the process medium comprises a chloride ion.

53. The method according to claim 51, wherein the ion transport mechanism comprises or consists of one or more selected from a selectively permeable ion exchange membrane system and an ion exchange resin system.

54. The method according to claim 51, wherein transporting the target ion comprised in the capture medium to the process medium comprises providing a concentration gradient of the target ion in the direction from the capture medium to the process medium.

55. The method according to claim 51, wherein the flow of ions between the capture medium and process medium to maintain charge balance comprises one or more of a flow of a negative ion from the process medium to the capture medium, and a flow of a positive ion from the capture medium to the process medium.

56. The method according to claim 55, wherein the flow of a negative ion from the process medium to the capture medium is carried out along a concentration gradient of the negative ion in the direction from the process medium to the capture medium.

57. The method according to claim 55, wherein the flow of a positive ion from the capture medium to the process medium is carried out against a concentration gradient of the positive ion in the direction from the capture medium to the process medium.

58. The method according to claim 57, wherein the method further comprises applying an electrical potential across the ion transport mechanism for flow of the positive ion from the capture medium to the process medium.

59. The method according to claim 51, wherein the method further comprises removing the compound from the process medium.

60. The method according to claim 51, wherein the method further comprises regenerating the capture medium and/or the process medium.

61. The method according to claim 51, wherein the compound precipitates or aerates from the process medium.

62. An apparatus for removing a target substance from a gas, the apparatus comprising:
a capture medium comprising an alkaline aqueous solution for dissolving the target substance comprised in the gas to form a target ion in the capture medium,
a process medium comprising an aqueous solution having an ion with an electric charge opposite to that of the target ion, and which is adapted to interact with the target ion to form a compound in the process medium, and
an ion transport mechanism adapted to allow transport of the target ion from the capture medium to the process medium, and a flow of ions between the capture medium and the process medium to maintain charge balance, wherein the ion transport mechanism is operable to have the target ion move from the capture medium to the process medium in the absence of an electrical potential.

63. The apparatus according to claim 62, wherein either one or both the capture medium and the process medium comprises a chloride ion.

64. The apparatus according to claim 62, wherein the ion transport mechanism comprises or consists of one or more selected from a selectively permeable ion exchange membrane system and an ion exchange resin system.

65. The apparatus according to claim 62, wherein concentration of the ion with an electric charge opposite to that of the target ion is higher in the process medium than in the capture medium.

66. The apparatus according to claim 62, wherein the compound precipitates from the process medium and the apparatus further comprises a process medium regeneration chamber adapted to receive the compound precipitated from the process medium.

67. The apparatus according to claim 62, wherein the compound precipitates from the process medium and the process chamber is configured to function as a process medium regeneration chamber adapted to receive the compound precipitated from the process medium.

68. The apparatus according to claim 67, wherein the process medium regeneration chamber is adapted to allow one or more of chemical treatment, heat treatment, and electrical treatment of the process medium to be carried out therein.
